(19) United States
(12) Patent Application Publication
(10) Pub. No.: US 2011/0244183 A1
(43) Pub. Date: Oct. 6, 2011

(54) RESIN COMPOSITION, CURED BODY AND MULTILAYER BODY

(75) Inventors: Nobuhiro Goto, Ibaraki (JP); Masaru Heishi, Tokyo (JP); Junnosuke Murakami, Ibaraki (JP)

(73) Assignee: Sekisui Chemical Co., Ltd., Osaka (JP)

(21) Appl. No.: 13/119,062

(22) PCT Filed: Sep. 18, 2009
(86) PCT No.: PCT/JP2009/004742

§ 371 Date: Jun. 10, 2011

(30) Foreign Application Priority Data
Sep. 24, 2008 (JP) 2008-244555

(51) Int. Cl. B32B 15/092; B32B 27/18; B32B 5/16

(52) U.S. Cl. 428/145; 428/331

(57) ABSTRACT

Provided is: a resin composition capable of reducing the surface roughness of the surface of a cured body obtained by having a roughening treatment performed thereon, and increasing the adhesive strength between the cured body and a metal layer; and a cured body formed by using the resin composition.

The resin composition according to the present invention includes an epoxy resin (A), a curing agent (B), and a silica component (C) in which silica particles are surface treated with a silane coupling agent. The silica component (C) includes a silica component (C1) having a particle diameter of 0.2 to 1.0 μm. A contained amount of the silica component (C1) is within a range from 30 to 100 vol % in 100 vol % of the silica component (C). A contained amount of the silica component (C) is within a range from 11 to 68 vol % in 100 vol % of the resin composition. A cured body 1 is formed by having a roughening treatment performed on a reactant obtained through a reaction of the resin composition. The surface of the cured body 1 on which the roughening treatment is performed has an arithmetic mean roughness Ra equal to or less than 0.3 μm and a ten-point mean roughness Rz equal to or less than 3.0 μm.

### TECHNICAL FIELD

The present invention relates to a resin composition including an epoxy resin, a curing agent, and a silica component, and more specifically, relates to a resin composition used for obtaining, for example, a cured body having a copper plating layer or the like formed on a surface thereof, and a cured body and a laminated body using the resin composition.

### BACKGROUND ART

Conventionally, various thermosetting resin compositions are used to form multilayer substrates, semiconductor devices, or the like.

For example, patent literature 1 described below discloses an epoxy resin composition including a bisphenol A type epoxy resin, a modified phenol novolac type epoxy resin having a structure of phosphaphenanthrenes within the molecule, a phenol novolac curing agent having a triazine ring within the molecule, and an inorganic filler. A preferable contained amount of the inorganic filler disclosed here is approximately 10 to 50 mass % in 100 mass % of the epoxy resin composition. Further disclosed here is about an inorganic filler having an average particle diameter equal to or smaller than 1 μm being preferable, and an inorganic filler having an average particle diameter equal to or smaller than 0.5 μm being particularly preferable.

### CITATION LIST

### Patent Literature

[PTL 1] Japanese Laid-Open Patent Publication No. 2008-074929

### SUMMARY OF THE INVENTION

### Problems to be Solved by the Invention

However, with patent literature 1, there are cases where the surface roughness of the surface of a resin insulation layer obtained by having a roughening treatment performed did not become sufficiently small. Furthermore, when a metal layer is formed on the surface of the resin insulation layer by plate processing, there are cases where the adhesive strength between the resin insulation layer and the metal layer is low.

An objective of the present invention is to provide: a resin composition capable of reducing the surface roughness of the surface of a cured body obtained by having a roughening treatment performed, and, when a metal layer is formed on the surface of the roughening-treated cured body, capable of increasing the adhesive strength between the cured body and the metal layer; and a cured body and a laminated body using the resin composition.

### Solution to the Problems

Provided with the present invention is a resin composition comprising an epoxy resin (A), a curing agent (B), a silica component (C) in which silica particles are surface treated with a silane coupling agent. The silica component (C) includes a silica component (C1) having a particle diameter of 0.2 to 1.0 μm. A contained amount of the silica component (C1) is within a range from 30 to 100 vol % in 100 vol % of the silica component (C). A contained amount of the silica component (C) is within a range from 11 to 68 vol % in 100 vol % of the resin composition.

In a specific aspect of the resin composition according to the present invention, the contained amount of the silica component (C1) is within a range from 65 to 100 vol % in 100 vol % of the silica component (C).

In another specific aspect of the resin composition according to the present invention, the silica component (C) does not include a silica component (C2) having a particle diameter larger than 1.0 μm or further includes the silica component (C2), and a contained amount of the silica component (C2) is within a range from 0 to 15 vol % in 100 vol % of the silica component (C).

In still another specific aspect of the resin composition according to the present invention, the silica component (C) does not include a silica component (C3) having a particle diameter smaller than 0.2 μm or further includes the silica component (C3), and a contained amount of the silica component (C3) is within a range from 0 to 50 vol % in 100 vol % of the silica component (C).

In still another specific aspect of the resin composition according to the present invention, a maximum particle diameter of the silica component (C) is equal to or smaller than 5 μm.

In still another specific aspect of the resin composition according to the present invention, the silica component (C) is a silica component in which 100 parts by weight of the silica particles are surface treated with 0.5 to 4.0 parts by weight of the silane coupling agent.

In another specific aspect of the resin composition according to the present invention, the epoxy resin (A) includes at least one type selected from the group consisting of epoxy resins having a naphthalene structure, epoxy resins having a dicyclopentadiene structure, epoxy resins having a biphenyl structure, epoxy resins having an anthracene structure, epoxy resins having a triazine backbone, epoxy resins having a bisphenol-A structure, and epoxy resins having a bisphenol-F structure.

In still another specific aspect of the resin composition according to the present invention, the curing agent (B) is at least one type selected from the group consisting of phenolic compounds having a naphthalene structure, phenolic compounds having a dicyclopentadiene structure, phenolic compounds having a biphenyl structure, phenolic compounds having an aminotriazine structure, active ester compounds, and cyanate ester resins.

In another specific aspect, the resin composition of the present invention further comprises an imidazole silane compound within a range from 0.01 to 3 parts by weight with regard to a total 100 parts by weight of the epoxy resin (A) and the curing agent (B).

A cured body according to the present invention is a cured body formed by having a roughening treatment performed on a reactant obtained through a reaction of the resin composition formed in accordance with the present invention. A surface on which the roughening treatment is performed has an arithmetic mean roughness Ra equal to or less than 0.3 μm and a ten-point mean roughness Rz equal to or less than 3.0 μm.

In a specific aspect of the cured body according to the present invention, the roughening treatment is performed on the reactant at 50° C. to 80° C. for 5 to 30 minutes.

In another specific aspect of the cured body according to the present invention, a swelling treatment is performed on the reactant before the roughening treatment.

In still another specific aspect of the cured body according to the present invention, the swelling treatment is performed on the reactant at 50° C. to 80° C. for 5 to 30 minutes.

A laminated body according to the present invention comprises the cured body formed in accordance with the present invention, and a metal layer formed by having a plate processing performed on the surface of the cured body. An adhesive strength between the cured body and the metal layer is equal to or larger than 4.9 N/cm.

### Advantageous Effects of the Invention

The surface roughness of the surface of the cured body obtained by having a roughening treatment performed thereon can be reduced; since the resin composition according to the present invention includes the epoxy resin (A), the curing agent (B), and the silica component (C) in which the silica particles are surface treated with the silane coupling agent; since the silica component (C1) having a particle diameter of 0.2 to 1.0 μm is included within a range from 30 to 100 vol % in 100 vol % of the silica component (C); and since the contained amount of the silica component (C) is within a range from 11 to 68 vol % in 100 vol % of the resin composition. Furthermore, when a metal layer such as a copper plating layer is formed on the surface of the cured body on which the roughening treatment is performed, the adhesive strength between the cured body and the metal layer can be increased.

### BRIEF DESCRIPTION OF THE DRAWINGS

FIG. 1 is a partially-cut front sectional view schematically showing a cured body according to one embodiment of the present invention.

FIG. 2 is a partially-cut front sectional view showing one example of a laminated body obtained by having a metal layer formed on the surface of the cured body.

FIG. 3 is a partially-cut front sectional view schematically showing one example of a multilayer laminated plate obtained by using a resin composition according to one embodiment of the present invention.

### DESCRIPTION OF EMBODIMENTS

The inventors of the present application have discovered that the surface roughness of the surface of a cured body obtained by having a roughening treatment performed thereon can be reduced and that the adhesive strength between the cured body and a metal layer can be increased, by using a composition including an epoxy resin (A), a curing agent (B), and a silica component (C) in which silica particles are surface treated with a silane coupling agent, by including a silica component (C1) having a particle diameter of 0.2 to 1.0 μm within a range from 30 to 100 vol % in 100 vol % of the silica component (C), and by having a contained amount of the silica component (C) within a range from 11 to 68 vol % in 100 vol % of the resin composition; and have perfected the present invention.

The resin composition according to the present invention includes an epoxy resin (A), a curing agent (B), and a silica component (C) in which silica particles are surface treated with a silane coupling agent. The silica component (C) includes a silica component (C1) having a particle diameter of 0.2 to 1.0 μm. A contained amount of the silica component (C1) is within a range from 30 to 100 vol % in 100 vol % of the silica component (C). A contained amount of the silica component (C) is within a range from 11 to 68 vol % in 100 vol % of the resin composition.

Characteristics of the present invention include, in particular, an inclusion of the silica component (C1) having the above described specific particle diameter in the silica component (C) at the above described specific volume fraction, and an inclusion of the silica component (C) in the resin composition at the above described specific volume fraction.

Conventionally, it has been difficult to satisfy both demands of reduction in the surface roughness of the surface of a cured body obtained by having a roughening treatment performed thereon, and increase in the adhesive strength between the cured body and a metal layer.

The present invention enables the reduction in the surface roughness of the surface of the cured body obtained by having a roughening treatment performed thereon, and the increase in the adhesive strength between the cured body and the metal layer, since the silica component (C1) having the above described specific particle diameter is included in the silica component (C) at the above described specific volume fraction, and since the silica component (C) is included in the resin composition at the above described specific volume fraction. In addition, a cured body that can be obtained has an arithmetic mean roughness Ra equal to or less than 0.3 μm and a tea-point mean roughness Rz equal to or less than 3.0 μm for the surface on which a roughening treatment is performed.

First, each component included in the resin composition according to the present invention will be described in the following.

(Epoxy Resin (A))

An epoxy resin (A) included in the resin composition according to the present invention is an organic compound including at least one epoxy group (oxirane ring). The number of epoxy groups in a single molecule of the epoxy resin (A) is equal to or more than one. The number of epoxy groups is preferably equal to or more than two.

A conventionally well-known epoxy resin can be used as the epoxy resin (A). With regard to the epoxy resin (A), a single type may be used by itself, or a combination of two or more types may be used. Furthermore, the epoxy resin (A) also includes an epoxy resin derivative or a hydrogenated compound of an epoxy resin.

The epoxy resin (A) includes, for example, an aromatic epoxy resin, an alicyclic epoxy resin, an aliphatic epoxy resin, a glycidyl ester type epoxy resin, a glycidyl amine type epoxy resin, a glycidyl acrylic type epoxy resin, a polyester type epoxy resin, or the like.

Other than the above described epoxy resins, an epoxy resin shown in the following may be used as the epoxy resin (A).

The epoxy resin (A) includes, for example, a compound obtained by modifying, through epoxidation, a carbon-carbon double bond of a (co)polymer having a conjugated diene compound as a main body thereof such as an epoxidized polybutadiene, an epoxidized dicyclopentadiene, or an epoxidized SBS, a compound obtained by modifying, through epoxidation, a carbon-carbon double bond of a partially hydrogenated compound of a (co)polymer having a conjugated diene compound as a main body thereof, or the like.

As the epoxy resin (A), an epoxy resin having flexibility is suitably used. Using a flexible epoxy resin can increase flexibility of the cured body.

The flexible epoxy resin includes: a diglycidyl ether of polyethylene glycol; a diglycidyl ether of polypropylene glycol; a poly glycidyl ether of a long chain polyol; a copolymer of glycidyl(meth)acrylate and a radical polymerizable monomer; a polyester resin including epoxy group; a compound obtained by modifying, through epoxidation, a carbon-carbon double bond of a (co)polymer having a conjugated diene compound as a main body thereof; a compound obtained by modifying, through epoxidation, a carbon-carbon double bond of a partially hydrogenated compound of a (co)polymer having a conjugated diene compound as a main body thereof; a urethane modified epoxy resin; a polycaprolactone modified epoxy resin; or the like.

Furthermore, the flexible epoxy resin includes a dimer acid modified epoxy resin obtained by introducing an epoxy group within a molecule of a dimer acid or a derivative of a dimer acid, a rubber modified epoxy resin obtained by introducing an epoxy group within a molecule of a rubber ingredient, or the like.

The rubber ingredient includes NBR, CTBN, polybutadiene, acrylic rubber, or the like.

The flexible epoxy resin preferably has a butadiene backbone. By using the flexible epoxy resin having a butadiene backbone, flexibility of the cured body can be further increased. In addition, the rate of elongation of the cured body can be increased in a broad temperature range from a low temperature range to a high temperature range.

A biphenyl type epoxy resin may be used as the epoxy resin (A). The biphenyl type epoxy resin includes a compound or the like obtained by substituting a part of hydroxyl groups of a phenolic compound with groups containing an epoxy group and by substituting the remaining hydroxyl groups with substituent groups other than hydroxyl group such as hydrogen.

The epoxy resin (A) preferably includes a component (A1) that is at least one type selected from the group consisting of epoxy resins having a naphthalene structure (naphthalene type epoxy resin), epoxy resins having a dicyclopentadiene structure (dicyclopentadiene type epoxy resin), epoxy resins having a biphenyl structure (biphenyl type epoxy resin), epoxy resins having an anthracene structure (anthracene type epoxy resin), epoxy resins having a triazine backbone (triazine backbone epoxy resin), epoxy resins having a bisphenol-A structure (bisphenol A type epoxy resin), and epoxy resins having a bisphenol-F structure (bisphenol F type epoxy resin). With regard to the contained amount of the component (A1) in 100 wt % of the epoxy resin (A), a preferable lower limit is 1 part by weight, a more preferable lower limit is 10 parts by weight, a further preferable lower limit is 20 parts by weight, an even further preferable lower limit is 50 parts by weight, a particularly preferable lower limit is 80 parts by weight, and a preferable upper limit is 100 parts by weight. It is preferable if the epoxy resin (A) is the component (A1). By using the component (A1), the surface roughness of the surfaces of a semi-cured body and a cured body can be further reduced.

The biphenyl type epoxy resin is preferably a biphenyl type epoxy resin represented by the following formula (8). By using this preferable biphenyl type epoxy resin, the linear expansion coefficient of the cured body can be further reduced.

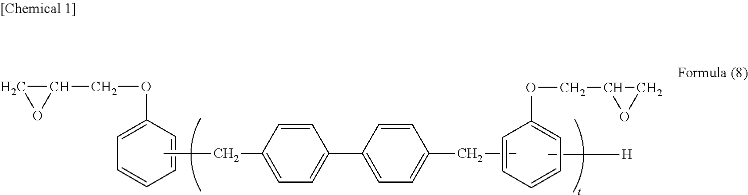

In the formula (8), t indicates an integer of 1 to 11.

The epoxy resin (A) is preferably a naphthalene type epoxy resin, an anthracene type epoxy resin, or a dicyclopentadiene type epoxy resin. By using this preferably epoxy resin, the linear expansion coefficient of the cured body can be reduced. The epoxy resin (A) is preferably an anthracene type epoxy resin or a triazine backbone epoxy resin, since the linear expansion coefficient of the cured body can be further reduced.

(Curing Agent (B))

There is no particular limitation in a curing agent (B) included in the resin composition according to the present invention, as long as it can cure the epoxy resin (A). A conventionally well-known curing agent can be used as the curing agent (B).

The curing agent (B) includes, for example, dicyandiamide, an amine compound, a derivative of an amine compound, a hydrazide compound, a melamine compound, an acid anhydride, a phenolic compound (phenol curing agent), an active ester compound, a benzoxazine compound, a maleimide compound, a heat latent cationic polymerization catalyst, a light latent cationic polymerization initiator, a cyanate ester resin, or the like. A derivative of these curing agents may also be used. With regard to the curing agent (B), a single type may be used by itself, or a combination of two or more types may be used. Furthermore, a curing catalyst such as acetylacetone iron may be used together with the curing agent (B).

The amine compound includes, for example, a linear aliphatic amine compound, a cyclic aliphatic amine compound, an aromatic amine compound, or the like.

Specific examples of a derivative of the above described amine compounds include a polyamino-amide compound, a polyamino-imide compound, a ketimine compound, or the like.

The polyamino-amide compound includes, for example, a compound synthesized from the amine compound and a carboxylic acid, or the like. The carboxylic acid includes, for example, succinic acid, adipic acid, azelaic acid, sebacic acid, dodecanedioic acid, isophthalic acid, terephthalic acid, dihydroisophthalic acid, tetrahydroisophthalic acid, hexahydroisophthalic acid, or the like.

The polyamino-imide compound includes, for example, a compound synthesized from the amine compound and a maleimide compound, or the like. The maleimide compound includes, for example, diaminodiphenylmethane bismaleimide or the like.

Furthermore, the ketimine compound includes, for example, a compound synthesized from the amine compound and a ketone compound, or the like.

The acid anhydride includes, for example, phthalic anhydride, trimellitic anhydride, pyromellitic anhydride, benzophenone tetracarboxylic anhydride, ethylene glycol bisanhydro trimellitate, glycerol trisanhydro trimellitate, methyl tetrahydrophthalic anhydride, tetrahydrophthalic anhydride, nadic anhydride, methyl nadic anhydride, trialkyl tetrahydrophthalic anhydride, hexahydrophthalic anhydride, methyl hexahydrophthalic anhydride, 5-(2,5-dioxotetrahydro furil)-3-methyl-3-cyclohexene-1,2-dicarboxylic anhydride, an adduct of trialkyl tetrahydrophthalic anhydride-maleic anhydride, dodecenyl succinic anhydride, polyazelaic anhydride, polydodecanedioic anhydride, chlorendic anhydride, or the like.

The light latent cationic polymerization catalyst includes, for example, an ionic light latent cationic polymerization initiator, or a nonionic light latent cationic polymerization initiator.

Specific examples of the ionic light latent cationic polymerization initiator include onium salts, organometallic complexes, or the like. The onium salts include, for example, an aromatic diazonium salt, an aromatic halonium salt, an aromatic sulfonium salt, or the like having, as a counter-anion, antimony hexafluoride, phosphorus hexafluoride, boron tetrafluoride, or the like. The organometallic complexes include, for example, an iron-allene complex, a titanocene complex, an aryl silanol-aluminium complex, or the like.

Specific examples of the nonionic light latent cationic polymerization initiator include a nitrobenzyl ester, a sulfonic acid derivative, a phosphate ester, a phenolsulfonic acid ester, diazonaphthoquinone, N-hydroxyimide sulfonate, or the like.

The phenolic compound includes, for example, a phenol novolac, an o-cresol novolac, a p-cresol novolac, a t-butyl phenol novolac, dicyclopentadiene cresol, a phenol aralkyl resin, an α-naphthol aralkyl resin, a β-naphthol aralkyl resin, an amino triazine novolac resin, or the like. Derivatives of these may be used as the phenolic compound. With regard to the phenolic compound, a single type may be used by itself, or a combination of two or more types may be used.

The phenolic compound can be suitably used as the curing agent (B). By using the phenolic compound, the heat resistance and the dimensional stability of the cured body can be increased, and water absorptivity of the cured body can also be reduced. Furthermore, the surface roughness of the surface of the cured body, which is obtained by having a roughening treatment performed on the reactant of the resin composition, can be further reduced. Specifically, the arithmetic mean roughness Ra and the ten-point mean roughness Rz of the surface of the cured body can be further reduced.

A phenolic compound represented by any one of the following formula (1), formula (2), and formula (3) is more suitably used as the curing agent (B). In this case, the surface roughness of the surface of the roughening-treated cured body can be even further reduced.

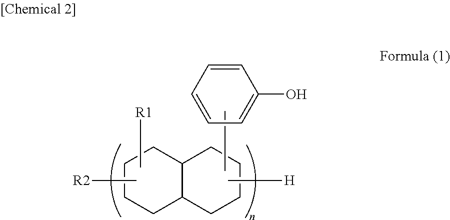

In the above described formula (1), R1 represents a methyl group or an ethyl group, R2 represents a hydrogen or a hydrocarbon group, and n represents an integer of 2 to 4.

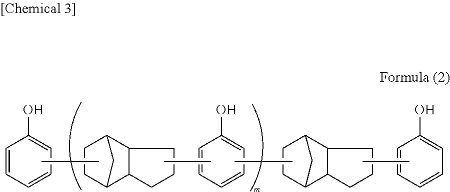

In the above described formula (2), m represents an integer of 0 to 5.

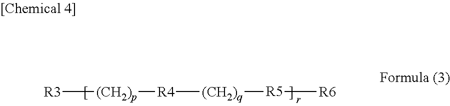

In the above described formula (3), R3 inmates a group represented by the following formula (4a) or formula (4b), R4 indicates a group represented by the following formula (5a), formula (5b), or formula (5c), R5 indicates a group represented by the following formula (6a) or formula (6b), R6 indicates a hydrogen or an organic group having a carbon number of 1 to 20, p represents an integer of 1 to 6, q represents an integer of 1 to 6, and r represents an integer of 1 to 11.

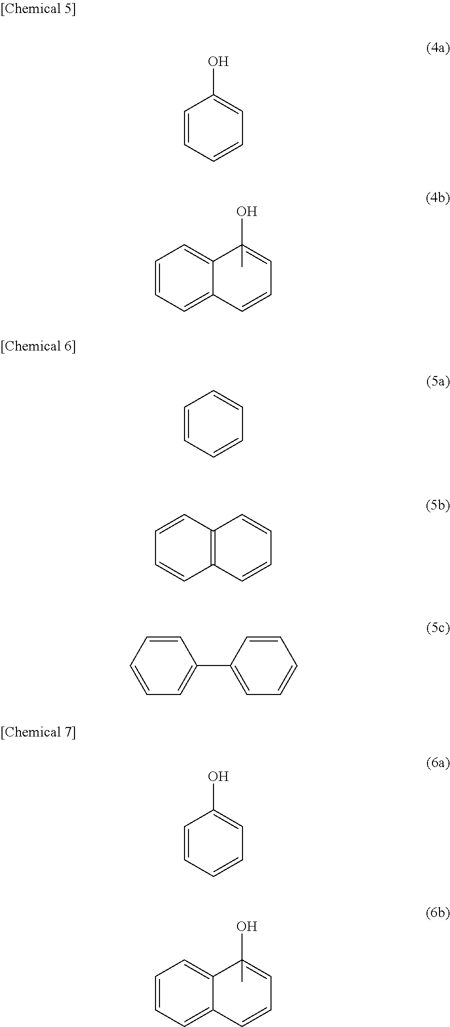

Among those, the phenolic compound having a biphenyl structure, which is a phenolic compound represented by the formula (3) and in which R4 in the formula (3) is a group represented by the formula (5c), is preferable. By using this preferable curing agent, the electrical property and the heat resistance of the cured body can be further increased, and the linear expansion coefficient and water absorptivity of the cured body can be further reduced. Furthermore, in case a thermal history is to be given to the cured body, the dimensional stability thereof can be further increased.

A phenolic compound having the structure shown in the following formula (7) is particularly preferable as the curing agent (B). In this case, the electrical property and the heat resistance of the cured body can be further increased, and the linear expansion coefficient and water absorptivity of the cured body can be further reduced. Furthermore, when a thermal history is to be given to the cured body, the dimensional stability thereof can be even further increased.

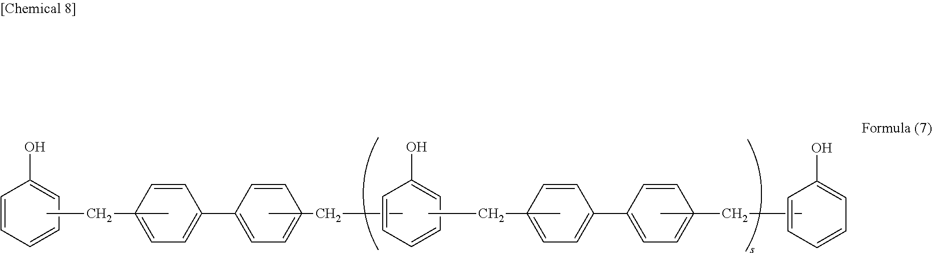

In the above described formula (7), s represents an integer of 1 to 11.

The active ester compound includes, for example, an aromatic multivalent ester compound or the like. When an active ester compound is used, a cured body having excellent dielectric constant and dielectric loss tangent can be obtained, since an OH group is not generated at the time of a reaction between the active ester group and the epoxy resin. Specific examples of the active ester compound are disclosed in, for example, Japanese Laid-Open Patent Publication No. 2002-12650.

Commercial items of the active ester compound include, for example, “EPICLON EXB9451-65T” and “EPICLON EXB9460S-65T”, which are product names and which are manufactured by DIC Corp., and the like.

The benzoxazine compound includes an aliphatic benzoxazine resin or an aromatic benzoxazine resin.

Commercial items of the benzoxazine compound include, for example, “P-d type benzoxazine” and “F-a type benzoxazine”, which are product names and which are manufactured by Shikoku Chemicals Corp., and the like.

For example, a novolac type cyanate ester resin, a bisphenol type cyanate ester resin, a prepolymer having one part thereof modified to have a triazine structure, and the like can be used as the cyanate ester resin. By using the cyanate ester resin, the linear expansion coefficient of the cured body can be further reduced.

The maleimide compound is preferably at least one type selected from the group consisting of N,N′-4,4-diphenylmethane bismaleimide, N,N′-1,3-phenylene dimaleimide, N,N′-1,4-phenylene dimaleimide, 1,2-bis(maleimide)ethane, 1,6-bismaleimide hexane, bis(3-ethyl-5-methyl-4-maleimide phenyl)methane, polyphenylmethane maleimide, bisphenol A diphenyl ether bismaleimide, 4-methyl-1,3-phenylene bismaleimide, 1,6-bismaleimide-(2,2,4-trimethyl)hexane, oligomers of these, and maleimide-backbone-containing diamine condensates. By using these preferable maleimide compounds, the linear expansion coefficient of the cured body can be further reduced, and the glass transition temperature of the cured body can be further increased. The above described oligomer is an oligomer obtained by condensating a maleimide compound which is a monomer among the above described maleimide compounds.

Among those, the maleimide compound is more preferably at least one of polyphenylmethane maleimide or a bismaleimide oligomer. The bismaleimide oligomer is preferably an oligomer obtained by condensating phenylmethane bismaleimide and 4,4-diaminodiphenylmethane. By using these preferably maleimide compounds, the linear expansion coefficient of the cured body can be even further reduced, and the glass transition temperature of the cured body can be even further increased.

Commercial items of the maleimide compound include polyphenylmethane maleimide (product name “BMI-2300” manufactured by Daiwa Fine Chemicals Co., Ltd.), a bismaleimide oligomer (product name “DAIMAID-100H” manufactured by Daiwa Fine Chemicals Co., Ltd.), and the like.

The curing agent (B) is preferably at least one type selected from the group consisting of phenolic compounds, active ester compounds, cyanate ester resins, and benzoxazine compounds. The curing agent (B) is more preferably at least one type selected from the group consisting of phenolic compounds, active ester compounds, and cyanate ester resins. When these preferable curing agents are used, and when a roughening treatment is performed on the reactant obtained through a reaction of the resin composition, the resin component is not likely to be subjected to adverse influences by the roughening treatment.

When the active ester compound is used as the curing agent (B), advantageous effects such as even better dielectric constant and dielectric loss tangent, and a superior fine-wiring formability are obtained. Therefore, for example, when the resin composition is used as an insulation material for build-ups, an advantageous effect of having a superior signal transmission particularly in a high frequency range can be expected.

When the active ester compound or the benzoxazine compound is used as the curing agent (B), a cured body having better dielectric constant and dielectric loss tangent can be obtained. The active ester compound is preferably an aromatic multivalent ester compound. By using the aromatic multivalent ester compound, a cured body having even better dielectric constant and dielectric loss tangent can be obtained.

It is particularly preferable if the curing agent (B) is a component (B1) that is at least one type selected from the group consisting of phenolic compounds having a naphthalene structure, phenolic compounds having a dicyclopentadiene structure, phenolic compounds having a biphenyl structure, phenolic compounds having an aminotriazine structure, active ester compounds, and cyanate ester resins. By using these preferable curing agents, when a roughening treatment is performed on the reactant, the resin component is even more unlikely to be subjected to adverse influences due to the roughening treatment. Specifically, during a roughening treatment, fine holes can be formed by selectively eliminating the silica component without excessively roughening the surface of the reactant. Thus, fine concavities and convexities with a very small surface roughness can be formed on the surface of the cured body. Among the above, the phenolic compounds having a biphenyl structure are preferable.

A cured body having a superior electrical property, in particular, having a superior dielectric loss tangent, and also having a superior strength and linear expansion coefficient, and additionally having a low water absorption rate, can be obtained by using a phenolic compound having a biphenyl structure, a phenolic compound having a naphthalene structure, or a cyanate ester resin.

If the molecular weights of the epoxy resin and the curing agent are high, it becomes easy to form a fine rough-surface on the surface of the cured body. The weight average molecular weight of the epoxy resin can influence the formation of a fine rough-surface. However, the weight average molecular weight of the curing agent can have a larger influence on the formation of a fine rough-surface than the weight average molecular weight of the epoxy resin. The weight average molecular weight of the curing agent is preferably equal to or higher than 500, and more preferably equal to or higher than 1800. A preferable upper limit of the weight average molecular weight of the curing agent is 15000.

If the epoxy equivalent of the epoxy resin and the equivalent amount of the curing agent are large, it becomes easy to form a fine rough-surface on the surface of the cured body. Furthermore, it becomes easy to form a fine rough-surface on the surface of the cured body if the curing agent is a solid, and if the softening temperature of the curing agent is equal to or higher than 60° C.

With regard to 100 parts by weight of the epoxy resin (A), the contained amount of the curing agent (B) is preferably within a range from 1 to 200 parts by weight. If the contained amount of curing agent (B) is too low, the resin composition may not be cured sufficiently. If the contained amount of the curing agent (B) is too high, the effect of curing the epoxy resin may reach saturation. With regard to 100 parts by weight of the epoxy resin (A), a preferable lower limit of the contained amount of the curing agent (B) is 30 parts by weight, and a preferable upper limit is 140 parts by weight.

(Curing Accelerator)

The resin composition according to the present invention preferably includes a curing accelerator. In the present invention, the curing accelerator is an optional component. There is no particular limitation in the curing accelerator.

The curing accelerator is preferably an imidazole curing accelerator. The imidazole curing accelerator is preferably at least one type selected from the group consisting of 2-undecylimidazole, 2-heptadecylimidazole, 2-methylimidazole, 2-ethyl-4-methylimidazole, 2-phenylimidazole, 2-phenyl-4-methylimidazole, 1-benzyl-2-methylimidazole, 1-benzyl-2-phenylimidazole, 1,2-dimethylimidazole, 1-cyanoethyl-2-methylimidazole, 1-cyanoethyl-2-ethyl-4-methylimidazole, 1-cyanoethyl-2-undecylimidazole, 1-cyanoethyl-2-phenylimidazole, 1-cyanoethyl-2-undecyl imidazolium trimeritate, 1-cyanoethyl-2-phenyl imidazolium trimeritate, 2,4-diamino-6-[2′-methyl imidazolyl-(1′)]-ethyl-s-triazine, 2,4-diamino-6-[2′-undecyl imidazolyl-(1′)]-ethyl-s-triazine, 2,4-diamino-6-[2′-ethyl-4′-methyl imidazolyl-(1′)]-ethyl-s-triazine, adducts of 2,4-diamino-6-[2′-methyl imidazolyl-(1′)]-ethyl-s-triazine isocyanuric acid, adducts of 2-phenyl imidazole isocyanuric acid, adducts of 2-methyl imidazole isocyanuric acid, 2-phenyl-4,5-dihydroxymethylimidazole, and 2-phenyl-4-methyl-5-dihydroxymethylimidazole.

Furthermore, the curing accelerator includes a phosphine compound such as triphenyl phosphine, diazabicycloundecene (DBU), diazabicyclononene (DBN), a phenol salt of DBU, a phenol salt of DBN, an octylic acid salt, a p-toluenesulfonic acid salt, a formate, an orthophthalate, a phenol novolac resin salt, or the like.

With regard to 100 parts by weight of the epoxy resin (A), the contained amount of the curing accelerator is preferably within a range from 0.01 to 3 parts by weight. If the contained amount of the curing accelerator is too low, the resin composition may not be cured sufficiently.

With the present invention, even when the curing accelerator is not added, the surface roughness can be reduced for the surface of the roughening-treated cured body. However, when the curing accelerator is not added, there are cases where the glass transition temperature Tg becomes low without a sufficient progress in the curing of the resin composition, and where the strength of the cured body fails to become sufficiently high. Therefore, the resin composition preferably includes the curing accelerator.

If the contained amount the curing accelerator is too high, even if the resin composition is semi-cured or cured, the molecular weight may not be sufficiently high and crosslinks in the epoxy resin may become inhomogeneous, since there will be many reaction starting points. Additionally, there is also a problem in which the preservation stability of the resin composition deteriorates. With regard to 100 parts by weight of the epoxy resin (A), a preferable lower limit of the contained amount of the curing accelerator is 0.5 parts by weight and a preferable upper limit is 2.0 parts by weight.

(Silica Component (C))

The resin composition according to the present invention includes a silica component (C) obtained by facing silica particles with a silane coupling agent. With regard to the silica component (C), a single type may be used by itself, or a combination of two or more types may be used. In addition, with regard to the silica component (C), for example, a combination of two or more types thereof having different particle size distributions may be used.

In the resin composition according to the present invention, the silica component (C) includes silica particles on which a surface treatment is performed by using a silane coupling agent, and includes the silica component (C1) having a particle diameter of 0,2 to 1.0 μm. The contained amount of the silica component (C1) is within a range from 30 to 100 vol % in 100 vol % of the silica component (C). As a result, a fine rough-surface can be formed on the roughening-treated cured body, and the adhesive strength between the cured body and the metal layer can be increased.

If the contained amount of the silica component (C1) in 100 vol % of the silica component (C) is less than 30 vol %, the surface roughness of the surface of the cured body may become large, and the adhesive strength may become small. If the contained amount of the silica component (C3) that has a particle diameter smaller than 0.2 μm becomes relatively large, although the surface roughness of the cured body becomes small, the adhesive strength becomes small. Furthermore, if the contained amount of the silica component (C2) that has a particle diameter larger than 1 μm becomes relatively large, the surface roughness of the surface of the cured body becomes large easily.

In 100 vol % of the silica component (C), the contained amount of the silica component (C1) that has a particle diameter of 0.2 to 1.0 μm is preferably within a range from 50 to 100 vol %, and more preferably within a range from 65 to 100 vol %. In this case, the surface roughness of the surface of the cured body can be further reduced, and the adhesive strength between the cured body and the metal layer can be further increased.

The silica component (C) includes silica particles on which a surface treatment is performed by using a silane coupling agent, and does not include the silica component (C2) having a particle diameter larger than 1.0 μm or includes the silica component (C2). The contained amount of the silica component (C2) is preferably within a range from 0 to 15 vol % in 100 vol % of the silica component (C). If the contained amount of the silica component (C2) satisfies the above described preferable upper limit, the silica component (C) can be easily eliminated when having a roughening treatment performed on the reactant obtained through a reaction of the resin composition, and thereby the adhesive strength between the cured body and the metal layer can be further increased. Furthermore, it becomes difficult for plating to slip into a void between the resin component and a silica component that has not been eliminated, and the surface roughness of the surface of the cured body can be further reduced.

The silica component (C) includes silica particles on which a surface treatment is performed by using a silane coupling agent, and does not include the silica component (C3) having a particle diameter smaller than 0.2 μm or includes the silica component (C3). The contained amount of the silica component (C3) is preferably within a range from 0 to 50 vol % in 100 vol % of the silica component (C). If the contained amount of the silica component (C3) satisfies the above described preferable upper limit, the contained amount of the silica component that has a large particle diameter becomes relatively large, and therefore, depths of holes formed on the surface of the cured body resulting from the elimination of the silica component (C) become deep. Therefore, the adhesive strength between the cured body and the metal layer can be further increased. In addition, the surface roughness of the surface of the cured body on which a roughening treatment is performed can be further reduced even when the swelling treatment and the roughening treatment is performed for a short period of time, since an interfacial area of an interface formed by the silica component (C) and the resin component becomes small, because the specific surface area of the silica having a large particle diameter is small due to a relatively large contained amount of the silica component that has a large particle diameter. Additionally, the water absorption rate of the cured body becomes low since the interfacial area of the interface formed by the silica component (C) and the resin component becomes small. Therefore, the insulation performance of the cured body will hardly deteriorate, and a change ratio of the electrical property of the cured body under a moisture absorbed condition becomes small.

The maximum particle diameter of the silica component (C) is preferably equal to or smaller than 5 μm. If the maximum particle diameter is equal to or smaller than 5 μm, the silica component (C) can be further easily eliminated when a roughening treatment is performed on the reactant. Furthermore, on the surface of the cured body on which a roughening treatment is performed, relatively large holes will hardly be generated, and uniform and fine concavities and convexities can be formed. When the maximum particle diameter is larger than 5 μm and when a metal layer is formed on the surface of the cured body as a circuit, the above described slipping-into of the plating may occur and a defect may occur in the circuit. For example, it becomes difficult to assure insulation reliability between wirings or between layers.

With regard to the mean particle diameter of the silica component (C), a value of median diameter (d50) representing 50% can be used. The mean particle diameter can be measured by using a particle-size-distribution measuring device utilizing laser diffraction dispersion method. From the measurement result of the mean particle diameter, the contained amount of a silica component that has a specific particle diameter can be calculated. Specifically, the particle diameter of a silica component can be measured, for example, by using a laser diffraction/dispersion type particle-size-distribution measuring device (model number “LA-750”; manufactured by HORIBA, Ltd.).

When a benzoxazine compound, an aromatic multivalent ester compound, or a phenolic compound, having a structure of any one of a naphthalene structure, a dicyclopentadiene structure, a biphenyl structure, and an aminotriazine structure, is used as the curing agent (B), it is difficult to remove the resin component from the periphery of the silica component (C) by a roughening treatment. In addition, when these curing agents are used and when the contained amount of the silica component (C2) is larger than 15 vol % in 100 vol % of the silica component (C), it becomes further difficult to eliminate the silica component (C), and the adhesive strength between the cured body and the metal layer tends to decrease easily. Therefore, when a benzoxazine compound, an aromatic multivalent ester compound, or a phenolic compound having a structure of any one of a naphthalene structure, a dicyclopentadiene structure, a biphenyl structure, and an aminotriazine structure, is used as the curing agent (B), the silica component (C2) is preferably not included or included at 15 vol % or less in 100 vol % of the silica component (C).

A plurality of types of silica particles having different mean particle diameters may be used. When considering close-packing, it is preferable to use the plurality of types of silica particles having different particle size distributions. In this case, the resin composition can be suitably used, for example, in a usage requiring fluidity such as a parts built-in substrate. Furthermore, by using silica particles having a mean particle diameter of several tens of nanometers, the viscosity of the resin composition can be increased and the thixotropism of the resin composition can be controlled.

When a benzoxazine compound, an aromatic multivalent ester compound, or a phenolic compound having a structure of any one of a naphthalene structure, a dicyclopentadiene structure, a biphenyl structure, and an aminotriazine structure, is used as the curing agent (B), it is difficult for a roughening liquid to penetrate from the surface of the reactant into the reactant which is obtained through a reaction of the resin composition, and it is relatively difficult to eliminate the silica component (C). However, by using the silica component (C1) in the above described specific volume fraction, the silica component (C) can be eliminated effortlessly. Furthermore the surface roughness of the surface of the cured body can be reduced and the adhesive strength between the cured body and the metal layer can be increased.

When forming fine wirings that have an L/S equal to or less than 15 μm/15 μm on the surface of the cured body, in 100 vol % of the silica component (C), the silica component (C2) is preferably not included or included at equal to or less than 15 vol %, and the maximum particle diameter of the silica component (C) is preferably equal to or smaller than 5 μm. In such case, insulation reliability can be increased since the slipping-into of the plating does not occur, and a substantive insulation distance can be ensured. Note that “L/S” represents: a wiring width direction dimension (L)/a dimension (S) in a width direction of a portion on which wirings are not formed.

There is no particular limitation in the shape of the silica particles. Examples of the shape of the silica particles include a spherical shape, an unfixed shape, or the like. In order to further easily eliminate the silica component when having a roughening treatment performed on the reactant, the silica particles is preferably spherical, and more preferably true-spherical.

The silica particles include, a crystalline silica obtained by grinding a natural silica material, a crushed-fused silica obtained by flame-fusing and grinding a natural silica material, a spherical fused silica obtained by flame-fusing, grinding, and then flame-fusing a natural silica material, a fumed silica (Aerosil), a synthetic silica such as a sol-gel processed silica, or the like.

A fused silica is suitably used as the silica particles since the purity thereof is high. The silica particles may be used as a silica slurry in a state of being dispersed in a solvent. When the silica slurry is used, workability and productivity during the production of the resin composition can be increased.

A general silane compound can be used as the silane coupling agent. The silane coupling agent is preferably at least one type selected from the group consisting of epoxy silanes, amino silanes, isocyanate silanes, acryloxy silanes, methacryloxy silanes, vinyl silanes, styryl silanes, ureido silanes, sulfide silanes, and imidazole silanes. Furthermore, a surface treatment of the silica particles may be conducted by using an alkoxy silane such as silazane. With regard to the silane coupling agent, a single type may be used by itself, or a combination of two or more types may be used.

It is preferable to add the silica component (C) to the resin composition after the silica component (C) is obtained by having a surface treatment performed on the silica particles by using the silane coupling agent. With this, the dispersibility of the silica component (C) can be further increased.

A method for performing a surface treatment on the silica particles by using the silane coupling agent includes, for example, the following first to third methods.

A dry method can be listed as the first method. The dry method includes, for example, a method of directly adhering the silane coupling agent to the silica particle, or the like. In the dry method, the silica particles are loaded in a mixer, and while agitating the silica particles, an alcohol solution or an aqueous solution of the silane coupling agent is dropped or sprayed therein. The mixture is further agitated and sorted using a sieve. Then, the silica component (C) can be obtained by dehydration condensation of the silane coupling agent and the silica particles through heating. The obtained silica component (C) may be used as a silica slurry in a state of being dispersed in a solvent.

A wet method can be listed as the second method. In the wet method, the silane coupling agent is added to a silica slurry containing the silica particles while agitating the silica slurry. After agitating, the mixture is filtered, dried, and sorted using a sieve. Then, the silica component (C) can be obtained by dehydration condensation of the silane compound and the silica particles through heating.

As the third method, a method of: adding the silane coupling agent while agitating a silica slurry containing the silica particle; and advancing dehydration condensation by heat reflux processing, can be listed. The obtained silica component (C) may be used as a silica slurry in a state of being dispersed in a solvent.

If untreated silica particles are used and when the resin composition is cured, the silica particles and the epoxy resin (A) will form a composite in a state of not being sufficiently compatible to each other. When the silica component (C) obtained by having a surface treatment performed on the silica particles by using the silane coupling agent is used, and when the resin composition is reacted, the silica component (C) and the epoxy resin (A) will form a composite in a state of being sufficiently compatible to each other at the interface of the two. As a result, the glass transition temperature Tg of the cured body increases. More specifically, instead of the untreated silica particles, when the silica component (C) obtained by having a surface treatment performed on the silica particles using the silane coupling agent is included in the resin composition, the glass transition temperature Tg of the cured body can be increased. In addition, since the dispersibility of the silica component (C) can be increased, a further homogeneous resin composition can be obtained. Furthermore, by increasing the dispersibility of the silica component (C), variation of the surface roughness of the surface of the roughening-treated cured body can be reduced.

Furthermore, by using the silica component (C), reflow tolerance of the cured body can be increased. In addition, water absorptivity of the cured body can be reduced, and insulation reliability of the cured body can be increased.

The contained amount of the silica component (C) is within a range from 11 to 68 vol % in 100 vol % of the resin composition according to the present invention. If the contained amount of the silica component (C) is lower than 11 vol %, when a roughening treatment is performed on the reactant obtained through a reaction of the resin composition, the total surface area of the holes formed resulting from the elimination of the silica component (C) becomes small. As a result, the adhesive strength between the cured body and the metal layer may not be increased sufficiently. If the contained amount of the silica component (C) is higher than 68 vol %, the cured body on which a roughening treatment is performed tends to be fragile, and the adhesive strength between the cured body and the metal layer may decrease.

In 100 vol % of the resin composition according to the present invention, a preferable lower limit of the contained amount of the silica component (C) is 12 vol %, and a more preferable lower limit is 18 vol %, and a preferable upper limit is 56 vol %, and a more preferable upper limit is 36 vol %. The adhesive strength between the cured body and the metal layer can be further increased when the contained amount of the silica component (C) is within this preferable range.

(Other Components that can be Added)

The resin composition described above preferably includes an imidazole silane compound. By using the imidazole silane compound, the surface roughness of the surface of the roughening-treated cured body can be further reduced.

With regard to a total 100 parts by weight of the epoxy resin (A) and the curing agent (B), the contained amount of the imidazole silane compound is preferably within a range from 0.01 to 3 parts by weight. When the contained amount of the imidazole silane compound is within the above described range, the surface roughness of the surface of the roughening-treated cured body can be further reduced, and the post-roughened adhesive strength between the cured body and the metal layer can be further increased. With regard to a total 100 parts by weight of the epoxy resin (A) and the curing agent (B), a preferable lower limit of the contained amount of the imidazole silane compound is 0.03 parts by weight, a more preferable upper limit is 2 parts by weight, and a further preferable upper limit is 1 part by weight. When the contained amount of the curing agent (B) is larger than 30 parts by weight to 100 parts by weight of the epoxy resin (A), it is particularly preferable to include the imidazole silane compound within a range from 0.01 to 2 parts by weight with regard to a total 100 parts by weight of the epoxy resin (A) and the curing agent (B).

The resin composition according to the present invention may include an organically modified sheet silicate.

In a resin composition including an organically modified sheet silicate, the organically modified sheet silicate exists in the surrounding areas of the silica component (C). Therefore, the silica component (C) existing on the surface of the reactant is more easily eliminated when a swelling treatment and a roughening treatment are performed on the reactant. This is presumed to be because the swelling liquid or roughening liquid also penetrates interfaces between the epoxy resin (A) and the silica component (C), in addition to the swelling liquid or roughening liquid penetrating a countless number of nano scale interfaces between layers of the organically modified sheet silicate or between the organically modified sheet silicate and the resin component. However the mechanism of how the silica component (C) becomes easily eliminated is not clear.

The organically modified sheet silicate includes, for example, organically modified sheet silicates obtained by organically modifying sheet silicates such as a smectite based clay mineral, a swelling mica, vermiculite, or halloysite. With regard to the organically modified sheet silicate, a single type may be used by itself, or a combination of two or more types may be used.

The smectite based clay mineral includes montmorillonite, hectorite, saponite, beidellite, stevensite, nontronite, or the like.

As the organically modified sheet silicate, an organically modified sheet silicate obtained by organically modifying at least one type of sheet silicate selected from the group consisting of montmorillonite, hectorite, and swelling mica may be suitably used.

The mean particle diameter of the organically modified sheet silicate is preferably equal to or smaller than 500 nm. If the mean particle diameter of the organically modified sheet silicate exceeds 500 nm, the dispersibility of the organically modified sheet silicate in the resin composition may decrease. The mean particle diameter of the organically modified sheet silicate is preferably equal to or larger than 100 nm.

With regard to the mean particle diameter of the organically modified sheet silicate, a value of median diameter (d50) representing 50% can be used. The mean particle diameter can be measured by using a particle-size-distribution measuring device that utilizes laser diffraction dispersion method.

The contained amount of the organically modified sheet silicate is preferably within a range from 0.01 to 3 parts by weight with regard to a total 100 parts by weight of the epoxy resin (A) and the curing agent (B). If the contained amount of the organically modified sheet silicate is too low, an effect of easily eliminating the silica component (C) can become insufficient. If the contained amount of the organically modified sheet silicate is too high, the number of the interfaces to be penetrated by the swelling liquid or roughening liquid becomes too large, and thereby the surface roughness of the surface of the cured body tends to be relatively large. Particularly when the resin composition is used as a sealing agent, if the contained amount of the organically modified sheet silicate becomes too high, since a penetration speed of the swelling liquid or the roughening liquid becomes faster, a speed at which the surface roughness of the surface of the cured body changes by a roughening treatment becomes too high, which may lead to cases where treatment time for a swelling treatment or a roughening treatment cannot be sufficiently ensured.

Note that, if the contained amount of the organically modified sheet silicate is higher than 3 parts by weight with regard to a total 100 parts by weight of the epoxy resin (A) and the curing agent (B), the surface roughness of the surface of the roughening-treated cured body tends to become relatively large.

When the organically modified sheet silicate is not used, the surface roughness of the surface of the roughening-treated cured body becomes further smaller. By adjusting the blend ratio of the silica component (C) and the organically modified sheet silicate, the surface roughness of the surface of the roughening-treated cured body can be controlled. Specifically, the surface roughness of the surface of the cured body can be lowly controlled, by blending a relatively large amount of the organically modified sheet silicate when the contained amount of the silica component (C) is small, and by not blending or blending a relatively small amount of the organically modified sheet silicate when the contained amount of the silica component (C) is large.

If necessary, in addition to the epoxy resin (A), the resin composition may include a resin that is copolymerizable with the epoxy resin (A).

There is no particular limitation in the above described copolymerizable resin. The copolymerizable resin includes, for example, a phenoxy resin, a thermosetting modified-polyphenylene ether resin, a benzoxazine resin, or the like. With regard to the copolymerizable resin, a single type may be used by itself, or a combination of two or more types may be used.

Specific examples of the thermosetting modified-polyphenylene ether resin include resins or the like obtained by modifying a polyphenylene ether resin using functional groups such as epoxy group, isocyanate group, or amino group. With regard to the thermosetting modified-polyphenylene ether resin, a single type may be used by itself, or a combination of two or more types may be used.

Commercial items of the cured-type modified-polyphenylene ether resin obtained by modifying a polyphenylene ether resin using epoxy group include, for example, “OPE-2Gly”, which is a product name and which is manufactured by Mitsubishi Gas Chemical Co., Inc., or the like.

There is no particular limitation in the benzoxazine resin. Specific examples of the benzoxazine resin include: a resin in which a substituent group having a backbone of an aryl group such as methyl group, ethyl group, phenyl group, biphenyl group, or cyclohexyl group, is coupled to the nitrogen of an oxazine ring; a resin in which a substituent group having a backbone of an allylene group such as methylene group, ethylene group, phenylene group, biphenylene group, naphthalene group, or cyclohexylene group, is coupled in between the nitrogen atoms of two oxazine rings; or the like. With regard to the benzoxazine resin, a single type may be used by itself, or a combination of two or more types may be used. As a result of a reaction between the benzoxazine resin and the epoxy resin (A), the heat resistance of the cured body can be enhanced, and water absorptivity and the linear expansion coefficient of the cured body can be reduced.

Note that, a monomer or an oligomer of benzoxazine, or a resin obtained by being given a high molecular weight by conducting a ring opening polymerization of the oxazine ring of a monomer or an oligomer of benzoxazine, is included in the benzoxazine resin.

To the resin composition, additives such as thermoplastic resins, thermosetting resins other than the epoxy resin (A), thermoplastic elastomers, crosslinked rubbers, oligomers, inorganic compounds, nucleating agents, antioxidants, antistaling agents, thermostabilizers, light stabilizers, ultraviolet ray absorbing agents, lubricants, flame-retarding auxiliary agents, antistatic agents, anticlouding agents, fillers, softening agents, plasticizing agents, coloring agents or the like may be added as necessary. With regard to these additives, a single type may be used by itself, or a combination of two or more types may be used.

Specific examples of the thermoplastic resins include polysulfone resins, polyethersulfone resins, polyimide resins, polyetherimide resins, phenoxy resins, or the like. With regard to the thermoplastic resins, a single type may be used by itself, or a combination of two or more types may be used.

The thermosetting resins include poly vinyl benzyl ether resins, reaction products obtained through a reaction of a bifunctional polyphenylene ether oligomer and chloromethylstyrene, or the like. Commercial items of the reaction products obtained through a reaction of the bifunctional polyphenylene ether oligomer and chloromethylstyrene include “OPE-2St”, which is a product name and which is manufactured by Mitsubishi Gas Chemical Co., Inc., or the like. With regard to the thermosetting resins, a single type may be used by itself, or a combination of two or more types may be used.

When the thermoplastic resins or the thermosetting resins are used, with regard to 100 parts by weight of the epoxy resin (A), the contained amount of the thermoplastic resins or the thermosetting resins is preferably within a range from 0.5 to 50 parts by weight, and more preferably within a range from 1 to 20 parts by weight. If the contained amount of the thermoplastic resins or the thermosetting resins is too low, there are cases where the elongation and the toughness of the cured body cannot be increased sufficiently, and if it is too high, there are cases where the strength of the cured body deteriorates.

(Resin Composition)

There is no particular limitation in the method for producing the resin composition according to the present invention. The method for producing the resin composition includes, for example, a method of adding, to a solvent, the epoxy resin (A), the curing agent (B), the silica component (C), and components blended as necessary, drying the mixture, and removing the solvent from the mixture.

The resin composition according to the present invention may be used, for example, after being dissolved in a suitable solvent.

There is no particular limitation in the usage of the resin composition according to the present invention. The epoxy resin composition can be suitably used as, for example, a substrate material for forming a core layer, a build-up layer, or the like of a multilayer substrate, an adhesion sheet, a laminated plate, a resin-coated copper foil, a copper clad laminated plate, a TAB tape, a printed-circuit substrate, a prepreg, a varnish, or the like.

In addition, by using the resin composition according to the present invention, fine holes can be formed on the surface of the cured body. Therefore, fine wirings can be formed on the surface of the cured body, and the signal transmission speed of the wirings can be increased. Thus, the resin composition can be suitable for usages requiring insulation characteristics, such as a resin-coated copper foil, a copper clad laminated plate, a printed-circuit substrate, a prepreg, an adhesion sheet, or a TAB tape.

The resin composition is suitably used in build-up substrates or the like in which cured bodies and conductive plating layers are layered by using the additive process and the semi-additive process to form circuits after forming a conductive plating layer on the surface of the cured body. In such a case, joining reliability of the conductive plating layers and the cured bodies can be increased. Furthermore, since the holes that are formed as a result of the silica component (C) being removed from the surface of the cured body are small, insulation reliability between patterns can be increased. Furthermore, since the depths of the holes resulting from the removal of the silica component (C) are shallow, insulation reliability between layers can be increased. Therefore, highly reliable fine wirings can be formed.

The resin composition can also be used as a sealing material, a solder resist, or the like. Furthermore, since high-speed signal transmission performance of the wirings formed on the surface of the cured body can be enhanced, the resin composition can also be used for a parts built-in substrate having built-in passive parts or active parts requiring high frequency characteristics.

The resin composition according to the present invention may be impregnated to a porous base material and may be used as a prepreg.

There is no particular limitation in the porous base material as long as it can be impregnated with the resin composition. The porous base material includes an organic fiber, a glass fiber, or the like. The organic fiber includes a carbon fiber, a polyamide fiber, a polyaramid fiber, a polyester fiber, or the like. Furthermore, the form of the porous base material includes textile forms such as textiles of plain weave fabrics or twill fabrics, forms such as nonwoven fabrics, or the like. The porous base material is preferably a glass fiber nonwoven fabric.

(Cured Body and Laminated Body)

A reactant can be obtained through a reaction of the resin composition according to the present invention. A cured body can be obtained by having a roughening treatment performed on the obtained reactant.

The obtained cured body is in a semi-cured state generally referred to as B stage. In the present specification, a cured body refers to those within a range from a semi-cured body to a cured body that is in a completely cured state. A semi-cured body is those that are not completely cured. A semi-cured body is one in which the curing can be further progressed.

Specifically, the cured body according to the present invention is obtained as described in the following.

The resin composition is reacted (preliminary-cured or semi-cured) to obtain a reactant. In order to adequately react the resin composition, the resin composition is reacted preferably by heating, light irradiation, or the like.

There is no particular limitation in the heating temperature during the reaction of the resin composition. The heating temperature is preferably within a range from 130° C. to 190° C. If the heating temperature is lower than 130° C., the concavities and convexities on the surface of the roughening-treated cured body tend to become large since the resin composition will not be cured sufficiently. If the heating temperature is higher than 190° C., the curing reaction of the resin composition tends to progress rapidly. Therefore, the degree of curing tends to differ locally, and rough portions and dense portions tend to form. As a result, the concavities and convexities on the surface of the cured body become large.

There is no particular limitation in the heating time for the reaction of the resin composition. The heating time is preferably equal to or longer than 30 minutes. If the heating time is shorter than 30 minutes, the concavities and convexities on the surface of the roughening-treated cured body become large, since the resin composition will not be sufficiently cured. From the standpoint of increasing productivity, the heating time is preferably equal to or longer than 1 hour.

In order to form fine concavities and convexities on the surface of the cured body, a roughening treatment is performed on the reactant. Before the roughening treatment, a swelling treatment is preferably performed on the reactant. However, the swelling treatment may not necessarily be performed on the reactant.

As the method for performing the swelling treatment, for example, a method of treating the reactant by using an aqueous solution or organic solvent dispersed solution of a compound having, as the main component, ethylene glycol or the like can be used. For the swelling treatment, a 40 wt % ethylene glycol aqueous solution is suitably used.

For the roughening treatment, for example, chemical oxidants such as a manganese compound, a chromium compound, a persulfuric acid compound, or the like can be used. These chemical oxidants are added to water or an organic solvent, and used as an aqueous solution or organic solvent dispersed solution.

The manganese compound includes potassium permanganate, sodium permanganate, or the like. The chromium compound includes potassium dichromate, potassium chromate anhydride, or the like. The persulfuric acid compound includes sodium persulfate, potassium persulfate, ammonium persulfate, or the like.

There is no particular limitation in the method for the roughening treatment. Suitably used for the roughening treatment is, for example, a permanganic acid or permanganate solution of 30 to 90 g/L, or a sodium hydroxide solution of 30 to 90 g/L.

If the roughening treatment is conducted for a large number of times, the roughening effect also becomes large. However, if the number of roughening treatments exceeds three, the roughening effect may reach saturation, or the resin component on the surface of the cured body is removed more than necessary and the holes on the surface of the cured body tend not to be formed in the shape obtained by the elimination of the silica component. Therefore, the roughening treatment is performed preferably once or twice.

The roughening treatment is preferably performed on the reactant at 50° C. to 80° C. for 5 to 30 minutes. When the swelling treatment is performed on the reactant, the swelling treatment is preferably performed on the reactant at 50° C. to 80° C. for 5 to 30 minutes. When the roughening treatment or the swelling treatment is performed multiple times, the above described time for the roughening treatment or the swelling treatment indicates the total duration of those. As a result of performing, by using the above described condition, the roughening treatment or the swelling treatment on the reactant obtained through a reaction of the above described specific resin composition, the surface roughness of the surface of the cured body can be further reduced. Specifically, a cured body having a roughening-treated surface with an arithmetic mean roughness Ra equal to or less than 0.3 μm, and a ten-point mean roughness Rz equal to or less than 3.0 μm can be further easily obtained.

The surface roughness of the surface of the roughening-treated cured body can be reduced, by using a reactant obtained through a reaction of a resin composition that includes the silica component (C1) at the above described specific volume fraction in the silica component (C), and that includes the silica component (C) at the above described specific volume fraction in the resin composition.

Furthermore, the inventors of the present application have discovered that the surface roughness of the surface of the roughening-treated cured body can be further reduced, and that the adhesive strength between the cured body and the metal layer can be further increased, by having specific ranges for volume fractions of the silica component (C3) having a particle diameter smaller than 0.2 μm, the silica component (C1) having a particle diameter of 0,2 to 1.0 μm, and the silica component (C3) having a particle diameter larger than 1.0 μm. In addition, it has been discovered that even further reduced surface roughness and even further increased adhesive strength can both be achieved by using the specific component (A1) as the epoxy resin (A), or by using the specific component (B1) as the curing agent (B).

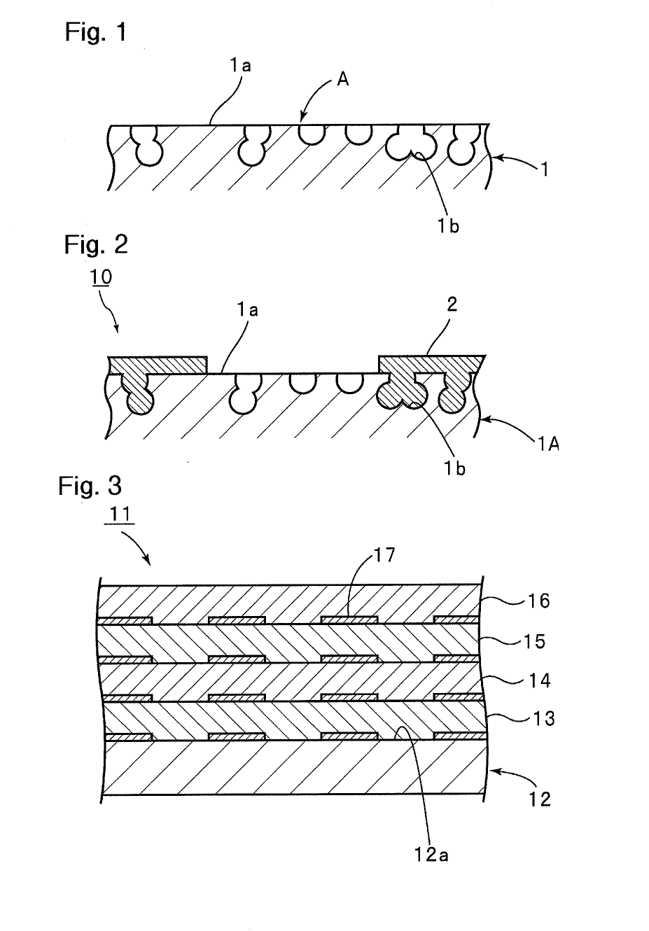

FIG. 1 is a partially-cut front sectional view schematically showing a cured body according to one embodiment of the present invention.

As shown in FIG. 1, holes 1b, which are formed resulting from the elimination of the silica component (C), are formed on a surface 1a of a cured body 1.

Since the silica component (C), which is obtained by having a surface treatment performed on the silica particles by using a silane coupling agent, is included in the resin composition according to the present invention, the dispersibility of the silica component (C) is excellent. Therefore, large holes resulting from elimination of aggregates of the silica component (C) hardly form on the cured body 1. Thus, the strength of the cured body 1 hardly deteriorates in a local manner, and the adhesive strength between the cured body 1 and the metal layer can be increased. Furthermore, a large amount of the silica component (C) can be blended in the resin composition in order to reduce the linear expansion coefficient of the cured body. Even when a large amount of the silica component (C) is blended, a plurality of fine holes 1b can be formed on the surface of the cured body 1. The holes 1b may be holes that result from elimination of a couple of pieces of the silica component (C), for example, 2 to 10 pieces.

The resin component has not been removed more than necessary from a portion show with arrow A in FIG. 1 in proximity of the holes 1b formed resulting from the elimination of the silica component (C). If, used as the curing agent (B) is, in particular, a phenolic compound having a structure of any one of a naphthalene structure, a dicyclopentadiene structure, a biphenyl structure, or an aminotriazine structure, an aromatic multivalent ester compound, or a compound having a benzoxazine structure; a relatively large amount of the resin component is easily removed from surfaces of the holes 1b formed resulting from the elimination of the silica component (C). However, when the silica component (C) is used, the resin component will not be removed more than necessary even when a phenolic compound having a structure of any one of a naphthalene structure, a dicyclopentadiene structure, a biphenyl structure, and an aminotriazine structure, an aromatic multivalent ester compound, or a compound having a benzoxazine structure is used as the curing agent (B). Therefore, the strength of the cured body can be increased.

With regard to the surface of the roughening-treated cured body 1 obtained as described above, preferably, the arithmetic mean roughness Ra is equal to or less than 03 μm, and the ten-point mean roughness Rz is equal to or less than 3.0 μm. With regard to the roughening-treated surface, the arithmetic mean roughness Ra is more preferably equal to or less than 0.2 μm, and further preferably equal to or less than 0.15 μm. With regard to the roughening-treated surface, the ten-point mean roughness Rz is more preferably equal to or less than 2 μm, and further preferably equal to or less than 1.5 μm. If the arithmetic mean roughness Ra is too large, or if the ten-point mean roughness Rz is too large, an increase in the transmission speed of electric signals through wirings formed on the surface of the cured body may not be achieved. The arithmetic mean roughness Ra and the ten-point mean roughness Rz can be obtained by using measuring methods conforming to JIS B0601-1994.

The plurality of holes formed on the surface of the cured body 1 preferably have a mean diameter equal to or smaller than 5 μm. If the mean diameter of the plurality of holes is larger than 5 μm, there will be cases where it becomes difficult to form wirings having a small L/S on the surface of the cured body, and the formed wirings will easily short-circuit.

As necessary, the cured body 1 can be provided with an electrolysis plating, after being treated with a publicly known catalyst for metal plating or being provided with a nonelectrolytic plating. By plate processing the surface of the cured body 1, a laminated body 10 that includes the cured body 1 and a metal layer 2 can be obtained. If the cured body 1 is in a semi-cured state, the cured body 1 is cured as necessary.

FIG. 2 shows a partially-cut front sectional view of the laminated body 10 obtained by forming the metal layer 2 on the upper surface 1a of the cured body 1 by plate processing. In the laminated body 10 shown in FIG. 2, the metal layer 2 extends into the fine holes 1b formed on the upper surface 1a of the cured body 1. Therefore, as a result of a physical anchoring effect, the adhesive strength between the cured body 1 and the metal layer 2 can be increased. Furthermore, since the resin component is not removed more than necessary in proximity of the holes 1b formed resulting from the elimination of the silica component (C), the adhesive strength between the cured body 1 and the metal layer 2 can be increased.

The smaller the mean particle diameter of the silica component (C) is, finer concavities and convexities can be formed on the surface of the cured body 1. Since the silica component (C1) having a relatively small particle diameter is included at a specific volume fraction in 100 vol % of the silica component (C), the holes 1b can be reduced in size; and therefore, fine concavities and convexities can be formed on the surface of the cured body 1. Thus, the L/S indicating the degree of fineness of the circuit wirings can be reduced.

When wirings of copper or the like having a small L/S are formed on the surface 1a of the cured body 1, the signal processing speed of the wirings can be increased. For example, even for a signal having a high frequency of 5 GHz or higher, loss of electric signals at an interface between the cured body 1 and the metal layer 2 can be reduced, since the surface roughness of the cured body 1 is small.

When the L/S is smaller than 45 μm/45 μm, the surface roughness of the surface of the roughening-treated cured body can be reduced, by using the resin composition in which the contained amount of the silica component (C1) is within a range from 30 to 100 vol % in 100 vol % of the silica component (C).

When the L/S is smaller than 13 μm/13 μm, the resin composition in which the contained amount of the silica component (C1) is within a range from 65 to 100 vol % in 100 vol % of the silica component (C) is preferably used. In addition, when the L/S is smaller than 13 μm/13 μm, a resin composition in which the silica component (C2) is not included or included at equal to or less than 15 vol % in 100 vol % of the silica component (C) is preferably used. Furthermore, when the L/S is smaller than 13 μm/13 μm, the maximum particle diameter of the silica component (C) is preferably equal to or smaller than 5 μm. In these cases described above, the surface roughness of the surface of the roughening-treated cured body can be reduced.

By forming a cured body by using the resin composition according to the present invention, fine wirings having a small surface roughness variation and an L/S of, for example, around 13 μm/13 μm can be formed on the surface of the cured body. Furthermore, fine wirings having an L/S of 10 μm/10 μm or smaller can be formed on the surface of the cured body 1 without resulting in a short circuit between the wirings. The cured body 1 having wirings formed thereon as described above can transmit electric signals stably with a small loss.

As a material for forming the metal layer 2, a metallic foil or metal plating which are used for shielding or for circuit formation, or a plating material used for circuit protection can be used.

The plating material includes, for example, gold, silver, copper, rhodium, palladium, nickel, tin, or the like. An alloy of two or more of these may be used, or a metal layer having multiple layers may be formed by using two or more of these types of plating materials. Furthermore, depending on the purpose, metals or substances other than the above described metals may be included in the plating material. The metal layer 2 is preferably a copper plating layer formed by copper plate processing.

In the laminated body 10, the adhesive strength between the cured body 1 and the metal layer 2 is preferably equal to or larger than 4.9 N/cm. The laminated body 10 can be used as a laminated plate.

(Sheet-Like Formed Body and Multilayer Laminated Plate)

A sheet-like formed body can be obtained by forming, into a sheet, the resin composition, the prepreg, or the cured body obtained by curing the resin composition or the prepreg.

Note that, in the present specification, a sheet also includes a film. In addition, the sheet may have self-sustainability, or may not have self-sustainability. The sheet-like formed body includes an adhesive sheet.

A method for forming the resin composition into a sheet includes, for example: an extrusion method of fusing and kneading the resin composition using an extruder, and after extrusion, forming it into a film shape by using a T die, a circular die, or the like; a mold casting method of dissolving or dispersing the resin composition in a solvent such as an organic solvent, and casting and forming it into a film shape; or conventionally well-known other sheet forming methods or the like. Among these, the extrusion method or the mold casting method is preferable, since advanced thinning can be achieved.

A multilayer laminated plate includes the sheet-like formed bodies forming a lamination, and at least one metal layer which is interposed between the sheet-like formed bodies. The multilayer laminated plate may further include a metal layer laminated on an outside surface of an outermost sheet-like formed body.

An adhesive layer may be disposed on at least one area of the sheet-like formed body of the multilayer laminated plate. Furthermore, an adhesive layer may be disposed on at least one area of the sheet-like formed bodies laminated in the multilayer laminated plate.

The metal layer of the multilayer laminated plate is preferably formed as a circuit. In this case, reliability of the circuit can be increased since the adhesive strength between the sheet-like formed body and the metal layer is high.

One example of the multilayer laminated plate using the resin composition according to one embodiment of the present invention is schematically shown as a partially-cut front sectional view in FIG. 3.

In a multilayer laminated plate 11 shown in FIG. 3, a plurality of cured bodies 13 to 16 are laminated on an upper surface 12a of a substrate 12. Metal layers 17 are formed in one area of the upper surfaces of the cured bodies 13 to 15 and not on the cured body 16 on the uppermost layer. Namely, a metal layer 17 is disposed in each of the interlayers of the laminated cured bodies 13 to 16. A lower metal layer 17 and an upper metal layer 17 are mutually connected by at least one of a via hole connection and a through hole connection, which are not shown.

In the multilayer laminated plate 11, the cured bodies 13 to 16 are formed by curing a sheet-like formed body obtained by forming, into a sheet, the resin composition according to one embodiment of the present invention. Therefore, fine holes which are not shown are formed on the surface of the cured bodies 13 to 16. In addition, the metal layers 17 extend into the fine holes. As a result, the adhesive strength between the metal layers 17 and the cured bodies 13 to 16 can be increased. Furthermore, for the multilayer laminated plate 11, a width-direction dimension (L) of the metal layers 17, and a dimension (S) in a width direction of a portion on which the metal layers 17 are not formed, can be reduced.

Note that, a film may be laminated on the surface of the above described sheet-like formed body or laminated plate for purposes such as transportation aid, and prevention of scratching or adherence of dust.

The film includes a resin coated paper, a polyester film, a polyethylene terephthalate (PET) film, a polybutylene terephthalate (PBT) film, a polypropylene (PP) film, or the like. Release processing to increase releasability may be conducted on the film as necessary.

A method of the release processing includes a method of including a silicon compound, a fluorine compound, a surfactant, or the like in the film, a method of providing concavities and convexities on the surface of the film, a method of applying, on the surface of the film, a substance having releasability such as a silicon compound, a fluorine compound, or a surfactant. The method of providing concavities and convexities on the surface of the film includes a method of embossing the surface of the film, or the like.

In order to protect the film, a protection film such as a resin coated paper, a polyester film, a PET film, or a PP film may be laminated on the film.

To obtain the above described volume fraction, it is necessary to measure the true specific gravity. When measuring the true specific gravity, a measuring device using Archimedes' method as a measuring principle may be used.

The present invention will be described specifically in the following by showing Examples and Comparative Examples. The present invention is not limited to the following examples.

In the Examples and Comparative Examples, materials shown in the following were used.

(Epoxy Resin)

Biphenyl type epoxy resin (manufactured by Nippon Kayaku Co., Ltd.; product name “NC-3000-H”; specific gravity: 1.17)

Bisphenol A type epoxy resin (manufactured by Nippon Kayaku Co., Ltd.; product name “RE-310S”; specific gravity: 1.17)

Anthracene type epoxy resin (manufactured by Japan Epoxy Resins Co., Ltd.; product name “YX8800”; specific gravity: 1.17)

Naphthalene type epoxy resin (manufactured by Nippon Kayaku Co., Ltd.; product name “NC-7300L”; specific gravity: 1.17)

Triazine backbone containing epoxy resin (manufactured by Nissan Chemical Industries, Ltd.; product name “TEPIC-SP”; specific gravity: 1.45)

(Curing Agent)

Phenol curing agent having biphenyl structure (manufactured by Meiwa Plastic Industries, Ltd.; product name “MEH7851-4H”; corresponding to the phenolic compound represented by the above described formula (7); specific gravity 1.17)

α-naphthol type phenol curing agent (manufactured by Tohto Kasei Co., Ltd.; product name “SN-485”; specific gravity 1.20)

Active ester compound (manufactured by DIC Corp.; product name “EPICLON EXB9460S-65T”; toluene solution having 65 wt % solid content; specific gravity: 1.22)

Cyanate ester resin (manufactured by Lonza Group Ltd.; product name “PRIMASET BA-230S”; methyl ethyl ketone solution having 75 wt % solid content; specific gravity of solution: 1.09; specific gravity of cyanate ester resin by itself: 1.18)

(Curing Accelerator)

Imidazole curing accelerator (manufactured by Shikoku Chemicals Corp.; product name “2PN-CN”; 1-cyanoethyl-2-methylimidazole; specific gravity 1.26)

(Silica Slurry)

50 wt % silica component (1) containing slurry:

50 wt % silica component (1) containing slurry including 50 wt % of a silica component (1) (specific gravity 2.20) obtained by performing a surface treatment on 100 parts by weight of silica particles (manufactured by Admatechs Co., Ltd.; product name “SOC1”) using 2 parts by weight of an amino silane (manufactured by Shin-Etsu Chemical Co., Ltd.; product name “KBM-573”), and 50 wt % of DMF (N,N-dimethylformamide).

50 wt % silica component (2) containing slurry:

50 wt % silica component (2) containing slurry including 50 wt % of a silica component (2) (specific gravity 2.20) obtained by performing a surface treatment on 100 parts by weight of silica particles (manufactured by Tatsumori Ltd.; product name “1-Fx”) using 2 parts by weight of an amino silane (manufactured by Shin-Etsu Chemical Co., Ltd.; product name “KBM-573”), and 50 wt % of DMF.

30 wt % silica component (3) containing slurry:

30 wt % silica component (3) containing slurry including 30 wt % of a silica component (3) (specific gravity 2.20) obtained by performing a surface treatment on 100 parts by weight of silica particles (manufactured by Denki Kagaku Kogyo K. K.; product name “UFP-80”) using 2 parts by weight of an amino silane (manufactured by Shin-Etsu Chemical Co., Ltd.; product name “KBM-573”), and 70 wt % of DMF.

50 wt % silica component (4) containing slurry:

50 wt % silica component (2) containing slurry including 50 wt % of a silica component (4) (specific gravity 2.20) obtained by performing a surface treatment on 100 parts by weight of silica particles (manufactured by Denki Kagaku Kogyo K. K.; product name “B-21”) using 2 parts by weight of an amino silane (manufactured by Shin-Etsu Chemical Co., Ltd.; product name “KBM-573”), and 50 wt % of DMF.

Particle size distributions of slurries containing the above described silica components (1) to (4) were measured. The following Table 1 shows contained amounts of silica components having particle diameters smaller than 0.2 μm, silica components having particle diameters of 0.2 to 1.0 μm, and silica components having particle diameters larger than 1.0 μm, in 100 vol % of silica components included respectively in the above described silica components (1) to (4) containing slurries. In addition, maximum particle diameters of silica components included respectively in the above described silica components (1) to (4) containing slurries are shown in the following Table 1. The particle diameters of the silica components were measured by using a laser diffraction/dispersion type particle-size-distribution measuring device (model number “LA-750”; manufactured by HORIBA, Ltd.).

TABLE 1

| | Silica | Silica | Silica | Silica |
|---|---|---|---|---|
| | Component | Component | Component | Component |
| | (1) | (2) | (3) | (4) |
| vol % of Silica Components having Particle | 20 | 37 | 100 | 0 |
| Diameters smaller than 0.2 μm *1 | | | | |
| vol % of Silica Components having Particle | 74 | 63 | 0 | 18 |
| Diameters of 0.2 to 1.0 μm *1 | | | | |
| vol % of Silica Components having Particle | 6 | 0 | 0 | 82 |
| Diameters larger than 1.0 μm *1 | | | | |
| Maximum Particle Diameter (μm) | 5.0 | 5.0 | 1.0 | 6.0 |

*1 Contained Amounts in 100 vol % of total Silica Components

(Solvent)

N,N-dimethylformamide (DMF; special grade; manufactured by Wako Pure Chemical Industries, Ltd.)

### EXAMPLE 1

(1) Preparation of Resin Composition

53.08 g of 50 wt % silica component (1) containing shirty and 7.00 g of DMF were mixed, and agitated at an ordinary temperature until a homogeneous solution was obtained. Then, 0.20 g of the above described imidazole curing accelerator (manufactured by Shikoku Chemicals Corp; product name “2PN-CN”) was further added, and agitated at an ordinary temperature until a homogeneous solution was obtained.

Next, 18.61 g of a bisphenol A type epoxy resin (manufactured by Nippon Kayaku Co., Ltd.; product name “RE-310S”) was added as an epoxy resin, and agitated at an ordinary temperature until it became a homogeneous solution, and thereby a solution was obtained. To the obtained solution, as a curing agent, 21.00 g of a phenol curing agent having a biphenyl structure (manufactured by Meiwa Plastic Industries, Ltd.; product name “MEH7851-4H”) was added, and agitated at an ordinary temperature until it became a homogeneous solution, and thereby a resin composition was prepared.

(2) Preparation of Un-Cured Object of Resin Composition

A transparent polyethylene terephthalate (PET) film on which release processing was conducted (product name “PET5011 550”; thickness 50 μm; manufactured by LINTEC Corp.) was prepared. The obtained resin composition was applied on this PET film by using an applicator such that its thickness after drying will be 50 μm. Next, the film was dried for 12 minutes at 100° C. inside a gear oven to prepare a sheet like un-cured object of the resin composition having a size of length 200 mm×width 200 mm×thickness 50 μm.

(3) Preparation of Cured Body

The obtained sheet-like un-cured object of the resin composition was vacuum-laminated on a glass epoxy substrate (FR-4; stock number “CS-3665”; manufactured by Risho Kogyo Co., Ltd.), and reacted at 150° C. for 60 minutes. In this manner, the reactant was formed on the glass epoxy substrate, and a lamination sample of the glass epoxy substrate and the reactant was obtained. Next, a swelling treatment described below was performed, and then a roughening treatment (permanganate treatment) described below was performed.

Swelling Treatment:

The lamination sample was placed in an 80° C. swelling liquid (Swelling Dip Securigant P; manufactured by Atotech Japan Co., Ltd.), and oscillated for 15 minutes at a swelling temperature of 80° C. Then, the lamination sample was rinsed with pure water.

Roughening Treatment (Permanganate Treatment):

The lamination sample having the swelling treatment performed thereon was placed in an 80° C. potassium permanganate (Concentrate Compact CP; manufactured by Atotech Japan Co., Ltd.) roughening solution, and oscillated for 15 minutes at a roughening temperature of 80° C. Next, the lamination sample was rinsed for 2 minutes with a 25° C. rinsing liquid (Reduction Securigant P; manufactured by Atotech Japan Co., Ltd.), and further rinsed with pure water. In the manner described above, a roughening-treated cured body A was formed on the glass epoxy substrate.

(4) Preparation of Laminated Body

Copper plate processing described below was performed after the above described roughening treatment.

Copper Plate Processing:

By using the following procedure, electroless copper plating and electrolytic copper plating were provided on the cured body formed on the glass epoxy substrate.

The surface of the roughening-treated cured body A was delipidated and rinsed by having it treated with a 60° C. alkaline cleaner (Cleaner Securigant 902) for 5 minutes. After rinsing, the cured body was treated with a 25° C. predip liquid (Pre-Dip Neogant B) for 2 minutes. Then, the cured body was treated with a 40° C. activator liquid (Activator Neogant 834) for 5 minutes to be provided with a palladium catalyst. Next, the cured body was treated with a 30° C. reduction liquid (Reducer Neogant WA) for 5 minutes.

Next, the cured body was placed in a chemically copper enriched liquid (Basic Printgant MSK-DK; Copper Printgant MSK; Stabilizer Printgant MSK) to apply a nonelectrolytic plating until the plating thickness was approximately 0.5 μm. After the nonelectrolytic plating, annealing was conducted for 30 minutes at a temperature of 120° C. in order to remove any residual hydrogen gas. All the processes up to the process of nonelectrolytic plating were conducted at a beaker scale with 1 L of processing liquids by oscillating the cured body.

Next, electrolysis plating was applied to the nonelectrolytic plating-processed semi-cured body until the plating thickness was 25 μm. Copper sulfate (Reducer Cu) was used for the electrolytic copper plating, and an electric current of 0.6 A/cm² was passed therethrough. Then, the cured body was heated at 180° C. for 1 hour to further cure the cured body. In the manner described above, a laminated body having a copper plating layer formed on the cured body was obtained.

### EXAMPLES 4 TO 14, AND COMPARATIVE EXAMPLES 1 TO 10

Resin compositions were prepared, and sheet like un-cured objects of the resin compositions, cured bodies, and laminated bodies were prepared similarly to Example 1, except for setting the types and blend amounts of used materials as shown in the following Tables 2 to 4. Note that, when a resin composition is to include an imidazole silane, the imidazole silane was added together with a curing agent.

(Evaluation)

(Preparation of Cured Body B)

Sheet like un-cured objects of resin compositions obtained from the Examples and Comparative Examples were heated at 170° C. for 1 hour and cured at 180° C. for 1 hour to obtain cured bodies B.

(1) Dielectric Constant and Dielectric Loss Tangent

Each of the obtained cured bodies B was cut so as to have a size of 15 mm×15 mm. Eight sheets of each of the cut cured bodies were layer to obtain a laminate having a thickness of 400 μm. Dielectric constant and dielectric loss tangent of the laminate at a frequency of 1 GHz at an ordinary temperature (23° C.) were measured by using a dielectric constant measuring device (stock number “HP4291B”; manufactured by Hewlett-Packard Co.).

(2) Average Linear Expansion Coefficient

The obtained cured bodies B were cut so as to have sizes of 3 mm×25 mm. An average linear expansion coefficient (α1) at 23° C. to 100° C. and an average linear expansion coefficient (α2) at 150° C. to 260° C. of the cut cured bodies were measured by using a linear-expansion-coefficient meter (stock number “TMA/SS120C”; manufactured by Seiko Instruments Inc.) with conditions of tension load of 2.94×10⁻² N and a temperature increase rate of 5° C./minute.

(3) Glass Transition Temperature (Tg)

The obtained cured bodies B were cut so as to have sizes of 5 mm×3 mm. Loss rates tan δ of the cut cured bodies were measured by using a Viscoelasticity Spectro-Rheometer (stock number “RSA-II”; manufactured by Rheometric Scientific F. E. Ltd.) in a range from 30° C. to 250° C. with a condition of a temperature increase rate of 5° C./minute, and temperatures at which the loss rates tan δ become maximum values (glass transition temperature Tg) were obtained.

(4) Breaking Strength and Breaking Point Elongation Rate

Each of the obtained cured bodies B was cut so as to have a size of 10×80 mm. Two of each of the cut cured bodies B were laminated and a test sample having a thickness of 100 μm was obtained. A breaking strength (MPa), and a breaking point elongation rate (%) of the test sample were measured by conducting tensile tests using a tensile testing machine (product name “Tensilon”; manufactured by Orientec Co., Ltd.) with a condition of 60 mm distance between chucks and a crosshead speed of 5 mm/minute.

(5) Post-Roughened Adhesive Strength

10-mm width notches were made on the surfaces of the copper plating layers of the laminated bodies obtained by forming the copper plating layers on the cured bodies. Then, adhesive strengths between the copper plating layers and the cured bodies were measured using a tensile testing machine (product name “Autograph”; manufactured by Shimadzu Corp.) with a condition of a crosshead speed of 5 mm/minute, and the obtained measured values were used as post-roughened adhesive strengths.

(6) Surface Roughness (Arithmetic Mean Roughness Ra and Ten-Point Mean Roughness Rz)

Arithmetic mean roughnesses Ra and ten-point mean roughnesses Rz of the surfaces of the roughening-treated cured bodies A were measured by using a non-contact type surface roughness meter (product name “WYKO”; manufactured by Veeco Instruments Inc.).

(7) Copper Adhesive Strength

The sheet like un-cured objects of resin compositions obtained from the Examples and Comparative Examples were respectively laminated on CZ treated copper foils (CZ-8301; manufactured by MEC Co., Ltd.) inside a vacuum, heated at 170° C. for 1 hour, further heated at 180° C. for 1 hour to be cured to obtain cured bodies with copper foils. Then, 10-mm width notches were made on the surfaces of the copper foils. Adhesive strengths between copper foils and cured bodies were measured by using a tensile testing machine (product name “Autograph”; manufactured by Shimadzu Corp.) with a condition of a crosshead speed of 5 mm/minute, and the measured adhesive strengths were used as copper adhesive strengths.

The results are shown in the following Tables 2 to 4.

TABLE 2

| | | | Exam- | Exam- | Exam- | Comparative | Comparative | Comparative | Comparative |
|---|---|---|---|---|---|---|---|---|---|
| | | | ple 1 | ple 2 | ple 3 | Example 1 | Example 2 | Example 3 | Example 4 |
| Blend | Epoxy Resin | Biphenyl Type Epoxy | | | 9.15 | | | 9.15 | 9.15 |
| Component | | Resin | | | | | | | |
| (parts by | | Bisphenol A Type Epoxy | 18.61 | 18.61 | 11.31 | 18.61 | 18.61 | 11.31 | 11.31 |
| weight) | | Resin | | | | | | | |
| | | Anthracene Type Epoxy | | | | | | | |
| | | Resin | | | | | | | |
| | | Naphthalene Type Epoxy | | | | | | | |
| | | Resin | | | | | | | |
| | | Triazine Backbone | | | | | | | |
| | | Containing Epoxy Resin | | | | | | | |
| | Curing Agent | Phenol Curing Agent | 21.00 | 21.00 | 19.15 | 21.00 | 21.00 | 19.15 | 19.15 |
| | | Having Biphenyl | | | | | | | |
| | | Structure | | | | | | | |
| | | α-Naphthol Type | | | | | | | |
| | | Phenol Curing Agent | | | | | | | |
| | | Active Ester Compound | | | | | | | |
| | | Cyanate Ester Resin | | | | | | | |
| | Curing Accelerator | Imidazole Curing | 0.20 | 0.20 | 0.20 | 0.20 | 0.20 | 0.20 | 0.20 |
| | | Accelerator | | | | | | | |
| | Silica Slurry | 50 wt % silica | 53.08 | | 53.08 | | | | |
| | | component (1) | | | | | | | |
| | | containing slurry | | | | | | | |
| | | 50 wt % silica | | 53.08 | | | | | |
| | | component (2) | | | | | | | |
| | | containing slurry | | | | | | | |
| | | 30 wt % silica | | | | 88.47 | | 88.47 | |
| | | component (3) | | | | | | | |
| | | containing slurry | | | | | | | |
| | | 50 wt % silica | | | | | 53.08 | | 53.08 |
| | | component (4) | | | | | | | |
| | | containing slurry | | | | | | | |
| | Solvent | N,N-dimethylformamide | 7.00 | 7.00 | 7.00 | | 7.00 | | 7.00 |
| | Imidazole Silane | Imidazole Silane | | | | | | | |
| | Compound | | | | | | | | |
| Contained Amount of Silica Component in 100 vol % of | | | 26.18 | 26.18 | 26.18 | 26.18 | 26.18 | 26.18 | 26.18 |
| Resin Composition (vol %) | | | | | | | | | |
| Evaluation | (1) Electrical | Dielectric Constant | 3.3 | 3.3 | 3.2 | 3.4 | 33 | 3.3 | 3.3 |
| | Properties | Dielectric Loss | 0.017 | 0.017 | 0.013 | 0.018 | 0.016 | 0.015 | 0.013 |
| | (1 GHz) | Tangent | | | | | | | |
| | (2) Average Linear | α1(×10⁵/° C.) | 37 | 37 | 34 | 39 | 37 | 36 | 35 |
| | Expansion Coefficient | α2(×10⁵/° C.) | 130 | 134 | 121 | 138 | 134 | 129 | 122 |
| | (3) Glass Transition | (° C.) | 171 | 171 | 178 | 170 | 171 | 178 | 178 |
| | Temperature Tg | | | | | | | | |
| | (4) Breaking Strength | (MPa) | 90 | 89 | 96 | 75 | 88 | 80 | 93 |
| | (4) Breaking Point | (%) | 5.4 | 4.8 | 6.0 | 3.1 | 5.1 | 4.9 | 5.4 |
| | Elongation Rate | | | | | | | | |
| | (5) Post-Roughened | (N/cm) | 9.8 | 6.9 | 8.8 | 2.9 | 1.0 | 3.9 | 1.0 |
| | Adhesive Strength | | | | | | | | |
| | (6) Surface Roughness | Arithmetic Mean | 0.06 | 0.08 | 0.06 | 0.36 | 0.45 | 0.32 | 0.41 |
| | | Roughness Ra | | | | | | | |
| | | (μm) | | | | | | | |
| | | Ten-Point Mean | 0.78 | 0.84 | 0.66 | 4.12 | 5.07 | 3.56 | 4.69 |
| | | Roughness Rz | | | | | | | |
| | | (μm) | | | | | | | |
| | (7) Copper Adhesive | (N/cm) | 9.8 | 9.8 | 8.8 | 6.9 | 9.8 | 7.8 | 9.8 |
| | Strength | | | | | | | | |

TABLE 3

| | | | Exam- | Exam- | Exam- | Comparative | Comparative | Comparative | Comparative |
|---|---|---|---|---|---|---|---|---|---|
| | | | ple 4 | ple 5 | ple 6 | Example 5 | Example 6 | Example 7 | Example 8 |
| Blend | Epoxy Resin | Biphenyl Type Epoxy | | | | | | | |
| Component | | Resin | | | | | | | |
| (parts by | | Bisphenol A Type Epoxy | 19.83 | 19.83 | 13.20 | 19.83 | 19.83 | 13.20 | 13.20 |
| weight) | | Resin | | | | | | | |
| | | Anthracene Type Epoxy | | | 6.67 | | | 6.67 | 6.67 |
| | | Resin | | | | | | | |
| | | Naphthalene Type Epoxy | | | | | | | |
| | | Resin | | | | | | | |
| | | Triazine Backbone | | | | | | | |
| | | Containing | | | | | | | |
| | | Epoxy Resin | | | | | | | |
| | Curing Agent | Phenol Curing Agent | | | | | | | |
| | | Having Biphenyl | | | | | | | |
| | | Structure | | | | | | | |
| | | α-Naphthol Type | 19.78 | 19.78 | 19.74 | 19.78 | 19.78 | 19.74 | 19.74 |
| | | Phenol Curing Agent | | | | | | | |
| | | Active Ester Compound | | | | | | | |
| | | Cyanate Ester Resin | | | | | | | |
| | Curing Accelerator | Imidazole Curing | 0.20 | 0.20 | 0.20 | 0.20 | 0.20 | 0.20 | 0.20 |
| | | Accelerator | | | | | | | |
| | Silica Slurry | 50 wt % silica | 53.08 | | 53.08 | | | | |
| | | component (1) | | | | | | | |
| | | containing slurry | | | | | | | |
| | | 50 wt % silica | | 53.08 | | | | | |
| | | component (2) | | | | | | | |
| | | containing slurry | | | | | | | |
| | | 30 wt % silica | | | | 88.47 | | 88.47 | |
| | | component (3) | | | | | | | |
| | | containing slurry | | | | | | | |
| | | 50 wt % silica | | | | | 53.08 | | 53.08 |
| | | component (4) | | | | | | | |
| | | containing slurry | | | | | | | |
| | Solvent | N,N-dimethylformamide | 7.00 | 7.00 | 7.00 | | 7.00 | | 7.00 |
| | Imidazole Silane | Imidazole Silane | | | | | | | |
| | Compound | | | | | | | | |
| Contained Amount of Silica Component in 100 vol % of | | | 26.42 | 26.42 | 26.42 | 26.42 | 26.42 | 26.42 | 26.42 |
| Resin Composition (vol %) | | | | | | | | | |
| Evaluation | (1) Electrical | Dielectric Constant | 3.3 | 3.3 | 3.2 | 3.4 | 3.3 | 3.3 | 3.2 |
| | Properties | Dielectric Loss | 0.015 | 0.015 | 0.018 | 0.017 | 0.015 | 0.020 | 0.018 |
| | (1 GHz) | Tanget | | | | | | | |
| | (2) Average Linear | α1(×10⁵/° C.) | 35 | 35 | 31 | 37 | 35 | 34 | 32 |
| | Expansion Coefficient | α2(×10⁵/° C.) | 126 | 127 | 120 | 130 | 129 | 130 | 124 |
| | (3) Glass Transition | (° C.) | 152 | 152 | 163 | 151 | 152 | 162 | 163 |
| | Temperature Tg | | | | | | | | |
| | (4) Breaking Strength | (MPa) | 86 | 85 | 83 | 71 | 81 | 68 | 80 |
| | (4) Breaking Point | (%) | 4.4 | 4.1 | 3.2 | 2.9 | 3.6 | 2.4 | 3.0 |
| | Elongation Rate | | | | | | | | |
| | (5) Post-Roughened | (N/cm) | 8.8 | 6.9 | 7.8 | 2.0 | 1.0 | 2.9 | 1.0 |
| | Adhesive Strength | | | | | | | | |
| | (6) Surface Roughness | Arithmetic Mean | 0.09 | 0.10 | 0.08 | 0.41 | 0.49 | 0.38 | 0.45 |
| | | Roughness Ra | | | | | | | |
| | | (μm) | | | | | | | |
| | | Ten-Point Mean | 1.04 | 1.32 | 0.96 | 4.52 | 5.33 | 4.12 | 4.96 |
| | | Roughness Rz | | | | | | | |
| | | (μm) | | | | | | | |
| | (7) Copper Adhesive | (N/cm) | 8.8 | 8.8 | 8.8 | 5.9 | 7.8 | 6.9 | 7.8 |
| | Strength | | | | | | | | |

TABLE 4

| | | | Exam- | Exam- | Exam- | Exam- | Exam- | Exam- |
|---|---|---|---|---|---|---|---|---|
| | | | ple 7 | ple 8 | ple 9 | ple 10 | ple 11 | ple 12 |
| Blend | Epoxy Resin | Biphenyl Type Epoxy | | | | | | |
| Components | | Resin | | | | | | |
| (parts by | | Bisphenol Type Epoxy | 26.93 | 6.67 | 15.35 | 19.38 | 13.67 | 18.61 |
| weight) | | Resin | | | | | | |
| | | Anthracene Type Epoxy | | | | | | |
| | | Resin | | | | | | |
| | | Naphthalene Type Epoxy | | | | | | |
| | | Resin | | | | | | |
| | | Triazine Backbone | | | 2.38 | | | |
| | | Containing | | | | | | |
| | | Epoxy Resin | | | | | | |
| | Curing Agent | Phenol Curing Agent | 30.38 | 7.52 | 21.88 | | 15.42 | 21.00 |
| | | Having Biphenyl | | | | | | |
| | | Structure | | | | | | |
| | | α-Naphthol Type Phenol | | | | | | |
| | | Curing Agent | | | | | | |
| | | Active Ester Compound | | | | 20.23 | | |
| | | Cyanate Ester Resin | | | | | 10.53 | |
| | Curing Accelerator | Imidazole Curing | 0.28 | 0.08 | 0.20 | 0.20 | 0.20 | 0.20 |
| | | Accelerator | | | | | | |
| | Silica Slurry | 50 wt % silica | 28.80 | 85.58 | 53.08 | 53.08 | 53.08 | 53.08 |
| | | component (1) | | | | | | |
| | | containing slurry | | | | | | |
| | | 50 wt % silica | | | | | | |
| | | component (2) | | | | | | |
| | | containing slurry | | | | | | |
| | | 30 wt % silica | | | | | | |
| | | component (3) | | | | | | |
| | | containing slurry | | | | | | |
| | | 50 wt % silica | | | | | | |
| | | component (4) | | | | | | |
| | | containing slurry | | | | | | |
| | Solvent | N,N-dimethylformamide | 12.93 | | 7.00 | 7.00 | 7.00 | 7.00 |
| | Imidazole Silane | Imidazole Silane | | | | | | 0.15 |
| | Compound | | | | | | | |
| Contained Amount of Silica Component in 100 vol % of | | | 11.74 | 61.47 | 26.18 | 26.18 | 26.18 | 26.18 |
| Resin Composition (vol %) | | | | | | | | |
| Evaluation | (1) Electrical | Dielectric Constant | 3.2 | 3.6 | 3.4 | 3.1 | 3.2 | 3.3 |
| | Properties | Dielectric Loss | 0.020 | 0.009 | 0.020 | 0.006 | 0.011 | 0.017 |
| | (1 GHz) | Tangent | | | | | | |
| | (2) Average Linear | α1(×10⁵/° C.) | 49 | 16 | 30 | 32 | 26 | 36 |
| | Expansion Coefficient | α2(×10⁵/° C.) | 150 | 65 | 110 | 122 | 104 | 122 |
| | (3) Glass Transition | (° C.) | 170 | 169 | 190 | 161 | 196 | 179 |
| | Temperature Tg | | | | | | | |
| | (4) Breaking Strength | (MPa) | 80 | 81 | 84 | 98 | 110 | 100 |
| | (4) Breaking Point | (%) | 8.0 | 2.0 | 4.0 | 4.1 | 4.1 | 5.6 |
| | Elongation Rate | | | | | | | |
| | (5) Post-Roughened | (N/cm) | 7.8 | 5.9 | 8.8 | 6.9 | 7.8 | 11.8 |
| | Adhesive Strength | | | | | | | |
| | (6) Surface Roughness | Arithmetic Mean | 0.04 | 0.28 | 0.10 | 0.05 | 0.16 | 0.04 |
| | | Roughness Ra | | | | | | |
| | | (μm) | | | | | | |
| | | Ten-Point Mean | 0.60 | 2.74 | 1.04 | 0.64 | 1.82 | 0.56 |
| | | Roughness Rz | | | | | | |
| | | (μm) | | | | | | |
| | (7) Copper Adhesive | (N/cm) | 11.8 | 7.8 | 9.8 | 7.8 | 11.8 | 11.8 |
| | Strength | | | | | | | |

| | | | Exam- | Exam- | Comparative | Comparative |
|---|---|---|---|---|---|---|
| | | | ple 13 | ple 14 | Example 9 | Example 10 |
| Blend | Epoxy Resin | Biphenyl Type Epoxy | | | | |
| Components | | Resin | | | | |
| (parts by | | Bisphenol Type Epoxy | 19.38 | 19.83 | 28.61 | 3.79 |
| weight) | | Resin | | | | |
| | | Anthracene Type Epoxy | | | | |
| | | Resin | | | | |
| | | Naphthalene Type Epoxy | | | | |
| | | Resin | | | | |
| | | Triazine Backbone | | | | |
| | | Containing | | | | |
| | | Epoxy Resin | | | | |
| | Curing Agent | Phenol Curing Agent | | | 32.28 | 4.27 |
| | | Having Biphenyl | | | | |
| | | Structure | | | | |
| | | α-Naphthol Type Phenol | | 19.78 | | |
| | | Curing Agent | | | | |
| | | Active Ester Compound | 20.23 | | | |
| | | Cyanate Ester Resin | | | | |
| | Curing Accelerator | Imidazole Curing | 0.20 | 0.20 | 0.30 | 0.04 |
| | | Accelerator | | | | |
| | Silica Slurry | 50 wt % silica | 53.08 | 53.08 | 21.60 | 91.80 |
| | | component (1) | | | | |
| | | containing slurry | | | | |
| | | 50 wt % silica | | | | |
| | | component (2) | | | | |
| | | containing slurry | | | | |
| | | 30 wt % silica | | | | |
| | | component (3) | | | | |
| | | containing slurry | | | | |
| | | 50 wt % silica | | | | |
| | | component (4) | | | | |
| | | containing slurry | | | | |
| | Solvent | N,N-dimethylformamide | 7.00 | 7.00 | 16.49 | |
| | Imidazole Silane | Imidazole Silane | 0.15 | 0.15 | | |
| | Compound | | | | | |
| Contained Amount of Silica Component in 100 vol % of | | | 26.18 | 26.42 | 8.58 | 75.08 |
| Resin Composition (vol %) | | | | | | |
| Evaluation | (1) Electrical | Dielectric Constant | 3.1 | 3.3 | 3.2 | 3.6 |
| | Properties | Dielectric Loss | 0.006 | 0.015 | 0.021 | 0.007 |
| | (1 GHz) | Tangent | | | | |
| | (2) Average Linear | α1(×10⁵/° C.) | 30 | 34 | 54 | 15 |
| | Expansion Coefficient | α2(×10⁵/° C.) | 118 | 116 | 165 | 60 |
| | (3) Glass Transition | (° C.) | 168 | 160 | 170 | 167 |
| | Temperature Tg | | | | | |
| | (4) Breaking Strength | (MPa) | 105 | 96 | 73 | 63 |
| | (4) Breaking Point | (%) | 3.9 | 4.7 | 8.8 | 1.0 |
| | Elongation Rate | | | | | |
| | (5) Post-Roughened | (N/cm) | 8.8 | 11.8 | 2.9 | 2.0 |
| | Adhesive Strength | | | | | |
| | (6) Surface Roughness | Arithmetic Mean | 0.04 | 0.06 | 0.03 | 0.38 |
| | | Roughness Ra | | | | |
| | | (μm) | | | | |
| | | Ten-Point Mean | 0.52 | 0.78 | 0.40 | 4.12 |
| | | Roughness Rz | | | | |
| | | (μm) | | | | |
| | (7) Copper Adhesive | (N/cm) | 9.8 | 11.8 | 11.8 | 4.9 |
| | Strength | | | | | |

### DESCRIPTION OF THE REFERENCE CHARACTERS

1 . . . cured body

1a . . . upper surface

1b . . . hole

2 . . . metal layer

10 . . . laminated body

11 . . . multilayer laminated plate

12 . . . substrate

12a . . . upper surface

13 to 16 . . . cured body

17 . . . metal layer

1. A cured body formed by having a roughening treatment performed on a reactant obtained through a reaction of a resin composition, comprising
a surface on which the roughening treatment is performed having an arithmetic mean roughness Ra equal to or less than 0.3 μm, and a ten-point mean roughness Rz equal to or less than 3.0 μm,
the resin composition including an epoxy resin (A), a curing agent (B), and a silica component (C) in which silica particles are surface treated with a silane coupling agent,
the silica component (C) including a silica component (C1) having a particle diameter of 0.2 to 1.0 μm,
an amount of the silica component (C1) being equal to or larger than 65 vol % in 100 vol % of the silica component (C),
the silica component (C) further including a silica component (C3) having a particle diameter smaller than 0.2 μm,
an amount of the silica component (C3) being equal to or smaller than 35 vol % in 100 vol % of the silica component (C),
an amount of the silica component (C) being within a range from 11 to 68 vol % in 100 vol % of the resin composition.

2. (canceled)

3. The cured body according to claim 1, wherein
the silica component (C) does not include a silica component (C2) having a particle diameter larger than 1.0 μm or further includes the silica component (C2), and
an amount of the silica component (C2) is within a range from 0 to 15 vol % in 100 vol % of the silica component (C).

4. (canceled)

5. The cured body according to claim 1, wherein a maximum particle diameter of the silica component (C) is equal to or smaller than 5 μm.

6. The cured body according to claim 1, wherein the silica component (C) is a silica component in which 100 parts by weight of the silica particles are surface treated with 0.5 to 4.0 parts by weight of the silane coupling agent.

7. The cured body according to claim 1, wherein the epoxy resin (A) includes at least one selected from the group consisting of epoxy resins having a naphthalene structure, epoxy resins having a dicyclopentadiene structure, epoxy resins having a biphenyl structure, epoxy resins having an anthracene structure, epoxy resins having a triazine backbone, epoxy resins having a bisphenol-A structure, and epoxy resins having a bisphenol-F structure.

8. The cured body according to claim 1, wherein the curing agent (B) is at least one selected from the group consisting of phenolic compounds having a naphthalene structure, phenolic compounds having a dicyclopentadiene structure, phenolic compounds having a biphenyl structure, phenolic compounds having an aminotriazine structure, active ester compounds, and cyanate ester resins.

9. The cured body according to claim 1, wherein the resin composition further includes an imidazole silane compound within a range from 0.01 to 3 parts by weight with regard to a total 100 parts by weight of the epoxy resin (A) and the curing agent (B).

10. (canceled)

11. The cured body according to claim 1, wherein the roughening treatment is performed on the reactant at 50° C. to 80° C. for 5 to 30 minutes.

12. The cured body according to claim 11, wherein a swelling treatment is performed on the reactant before the roughening treatment.

13. The cured body according to claim 12, wherein the swelling treatment is performed on the reactant at 50° C. to 80° C. for 5 to 30 minutes.

14. A laminated body comprising the cured body according to claim 1, and a metal layer formed by having plate processing performed on the surface of the cured body,
an adhesive strength between the cured body and the metal layer being equal to or larger than 4.9 N/cm.
